(19) United States
(12) Patent Application Publication
(10) Pub. No.: US 2013/0027546 A1
(43) Pub. Date: Jan. 31, 2013

(54) IMAGE MEASUREMENT APPARATUS, IMAGE MEASUREMENT METHOD, PROGRAM AND RECORDING MEDIUM

(71) Applicant: Tadashi Hayashi, Yokohama-shi (JP)

(72) Inventor: Tadashi Hayashi, Yokohama-shi (JP)

(73) Assignee: CANON KABUSHIKI KAISHA, Tokyo (JP)

(21) Appl. No.: 13/547,611

(22) Filed: Jul. 12, 2012

(30) Foreign Application Priority Data
Jul. 26, 2011 (JP) 2011-162770

(51) Int. Cl. H04N 7/18

(52) U.S. Cl. 348/135; 348/E07.085

(57) ABSTRACT

A marker is provided on a support member. A marker position detector detects a specific position of the marker from an image obtained by capturing an object to be measured and the marker by an image sensor. A shift amount calculator obtains a difference between a reference position of the specific position stored in a memory and the detected position, and calculates a shift amount of the image. A correction amount calculator obtains a correction amount, which cancels the calculated shift amount. An image corrector corrects the image with the obtained correction amount, thus obtaining the image with the distortion corrected. A measure measures a picture of the object to be measured by using the image with the distortion corrected. Accordingly, the distortion of the image is corrected with ease with respect to a relative movement between the object to be measured and the image sensor.

### BACKGROUND OF THE INVENTION

1. Field of the Invention

The present invention relates to an image measurement apparatus and method for generating an image by performing exposure and transfer for each line to obtain a picture of an object to be measured from the image, a program therefor and a recording medium.

2. Description of the Related Art

Hitherto, a method of measuring a picture of an object, such as a position and a shape, by using an image has been known. Unlike a measurement using a conventional distance measuring sensor, the method using the image has an advantage that two-dimensional information can be obtained at once or even three-dimensional information can be obtained at once by using a stereoscopic camera. A charge coupled device (CCD) image sensor has been mainly used as an image sensor of a camera used for an image pickup. In recent years, mostly for a high pixel camera, a complementary metal oxide semiconductor (CMOS) image sensor has become often used. The CMOS image sensor has an advantage that a pixel signal can be randomly accessed and reading can be performed easily at a high speed with a low power consumption compared to the CCD image sensor.

The CMOS image sensor is generally driven by a rolling shutter. This shutter mechanism is described with reference to (a) to (d) of FIG. 27.

(a) of FIG. 27 is a diagram illustrating exposure and read timings of a CCD image sensor to be compared. Each of line_1 to line_n starts exposure with the same reset signal and starts reading with a read_out signal having the same timing. Read signals are sequentially transmitted by the CCD image sensor in a bucket bridge scheme. A transmission path itself has a memory function, and hence the simultaneous exposure can be performed even when the last read line is one. As a result, even when shooting a moving object, there is no distortion of figure as illustrated in (b) of FIG. 27. This type of shutter system is called a “global shutter”.

On the other hand, (c) of FIG. 27 illustrates exposure and read timings of a CMOS image sensor employing a rolling shutter. Each of line_1 to line_n is exposed and read with a reset signal and a read out signal which are shifted by a predetermined time period such that data does not appear on the last read line in a simultaneous manner. As a result, unlike the CCD image sensor, this method sequentially scans two-dimensionally arranged a plurality of pixels for each line to read the pixel signal. For this reason, a time difference of virtually one vertical period is generated at top and bottom of the frame, and when there is a relative movement between the camera and the subject, the exposure time is shifted for each line. Specifically, when a moving subject is shot, the shot image is distorted as illustrated in (d) of FIG. 27. Particularly, when the movement of the subject is fast, the distortion of the image is increased. This problem also occurs in a camera employing a focal plane system shutter that scans a mechanical slit in the vertical direction.

To solve this problem, a method has been known in which a motion vector amount of a subject is detected from a difference between a previous frame and the next frame for a subject that moves in the horizontal direction to correct a distortion of an image in the horizontal direction (Japanese Patent Application Laid-Open No. 2009-141717). A distortion of the image in the vertical direction is corrected by detecting the distortion with a shake detector such as a gyro sensor which is an external sensor.

However, in the method disclosed in Japanese Patent Application Laid-Open No. 2009-141717, although a shift amount in the horizontal direction can be obtained from a calculation, a separate external sensor such as the gyro sensor is necessary to obtain a shift amount in the vertical direction. Therefore, not only this method is disadvantageous in cost and space, but also this method necessitates separate external sensors for both of the camera and the subject, and a circuit for taking synchronization between the separate external sensors, making the configuration considerably complicated.

### SUMMARY OF THE INVENTION

The present invention has an object to obtain, when obtaining a picture of an object to be measured by using an image obtained by an image pickup of a camera, a measured result for correcting a distortion of the image without using an external sensor such as a gyro sensor.

According to an exemplary embodiment of the present invention, there is provided an image measurement apparatus including a camera including an image sensor having a plurality of pixels, the camera being configured capture an image of an object to be measured by sequentially exposing the pixels of the image sensor for each line in a first scanning direction; a computation processing unit configured to obtain a picture of the object to be measured from the image captured by the camera; and a support member configured to support the object to be measured, the support member including a plurality of markers arranged in a manner intersecting the first scanning direction with a predetermined relative position therebetween, in which the computation processing unit is configured to detect positions of the plurality of markers on the image; obtain shift amounts of the positions of the plurality of markers in the first scanning direction and a second scanning direction with respect to reference positions of the plurality of markers in the first scanning direction and a second scanning direction for each line of the image; and obtain the picture of the object to be measured, the picture being corrected so that the shift amounts are canceled.

Further, according to another exemplary embodiment of the present invention, there is provided an image measurement method, which uses an image measurement apparatus including a camera including an image sensor having a plurality of pixels, the camera being configured to capture an image of an object to be measured by sequentially exposing the plurality of pixels of the image sensor for each line in a first scanning direction; a computation processing unit that obtains a picture of the object to be measured from the image captured by the camera, and a support member configured to support the object to be measured, the support member including a plurality of markers arranged in a manner intersecting the first scanning direction with a predetermined relative position therebetween, the image measurement method comprising detecting, by the computation processing unit, positions of the plurality of markers on the image; obtaining, by the computation processing unit, shift amounts of the positions of the plurality of markers in the first scanning direction and a second scanning direction with respect to reference positions of the plurality of markers for each line of the image; and obtaining, by the computation processing unit, the picture of the object to be measured, the picture being corrected so that the shift amounts are canceled.

According to the present invention, when obtaining the picture of the object to be measured by using an image obtained from an image pickup of the image sensor, a measured result with an image distortion corrected can be obtained without using an external sensor such as a gyro sensor.

Further features of the present invention will become apparent from the following description of exemplary embodiments with reference to the attached drawings.

### BRIEF DESCRIPTION OF THE DRAWINGS

FIG. 1 illustrates an explanatory diagram of an overall configuration of an image measurement apparatus according to a first embodiment of the present invention.

FIG. 2 illustrates explanatory diagrams of an image obtained from an image pickup according to the first embodiment of the present invention.

FIG. 3 illustrates explanatory diagrams of forms of distortion occurring when a workpiece makes a parallel movement relative to a vertical scanning direction of an image sensor of a camera according to the first embodiment of the present invention.

FIG. 4 is a functional block diagram of a camera and a controller according to the first embodiment of the present invention.

FIG. 5 is a flowchart illustrating an operation performed in advance by the camera and the controller before measuring a shape of the workpiece according to the first embodiment of the present invention.

FIG. 6 is a flowchart illustrating an operation when measuring a position and a shape of the workpiece by the camera and the controller according to the first embodiment of the present invention.

FIG. 7 is a flowchart illustrating operations of a shift amount calculator and a correction amount calculator according to the first embodiment of the present invention.

FIG. 8 illustrates diagrams of an operation of correcting an image according to the first embodiment of the present invention.

FIG. 9 is a functional block diagram of a camera and a controller of an image measurement apparatus according to a second embodiment of the present invention.

FIG. 10 is a flowchart illustrating an operation when measuring a position and a shape of a workpiece by the camera and the controller according to the second embodiment of the present invention.

FIG. 11 illustrates an explanatory diagram of an overall configuration of an image measurement apparatus according to a third embodiment of the present invention.

FIG. 12 is a flowchart illustrating an operation performed in advance by a camera and a controller before measuring a shape of a workpiece according to the third embodiment of the present invention.

FIG. 13 illustrates diagrams of an image measurement apparatus according to a fourth embodiment of the present invention.

FIG. 14 is a functional block diagram of a camera and a controller according to the fourth embodiment of the present invention.

FIG. 15 is a flowchart illustrating an operation performed in advance by the camera and the controller before measuring a shape of a workpiece according to the fourth embodiment of the present invention.

FIG. 16 is a flowchart illustrating an operation when measuring a position and a shape of the workpiece by the camera and the controller according to the fourth embodiment of the present invention.

FIG. 17 illustrates explanatory diagrams of various forms of markers.

FIG. 18A illustrates an explanatory diagram of an overall configuration of an image measurement apparatus according to a fifth embodiment of the present invention.

FIG. 18B illustrates an explanatory diagram of an image obtained from an image pickup according to the fifth embodiment of the present invention.

FIG. 19 illustrates diagrams of waveforms of markers on the image according to the fifth embodiment of the present invention.

FIG. 20 is a functional block diagram of a camera and a controller according to the fifth embodiment of the present invention.

FIG. 21 is a flowchart illustrating an operation when measuring a position and a shape of a workpiece by the camera and the controller according to the fifth embodiment of the present invention.

FIG. 22 is a functional block diagram of a camera and a controller of an image measurement apparatus according to a sixth embodiment of the present invention.

FIG. 23 is a flowchart illustrating an operation when measuring a position and a shape of a workpiece by a camera and a controller according to the sixth embodiment of the present invention.

FIG. 24A illustrates an explanatory diagram of an overall configuration of an image measurement apparatus according to a seventh embodiment of the present invention.

FIG. 24B illustrates an explanatory diagram of an image obtained from an image pickup according to the seventh embodiment of the present invention.

FIG. 25 is a functional block diagram of a camera and a controller according to the seventh embodiment of the present invention.

FIG. 26 is a flowchart illustrating an operation when measuring a position and a shape of a workpiece by the camera and the controller according to the seventh embodiment of the present invention.

FIG. 27 illustrates diagrams of exposure and transfer timings of a CCD image sensor and a CMOS image sensor.

### DESCRIPTION OF THE EMBODIMENTS

Exemplary embodiments of the present invention are now described in detail with reference to the accompanying drawings.

### First Embodiment

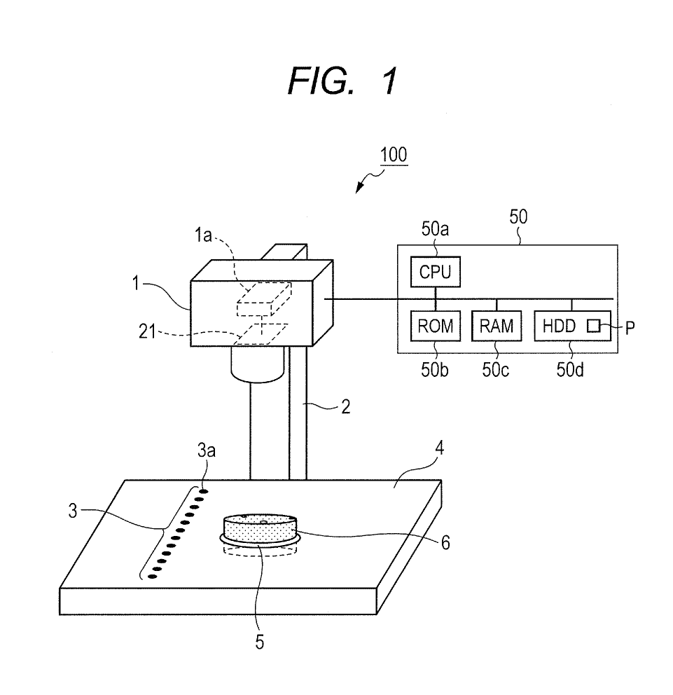

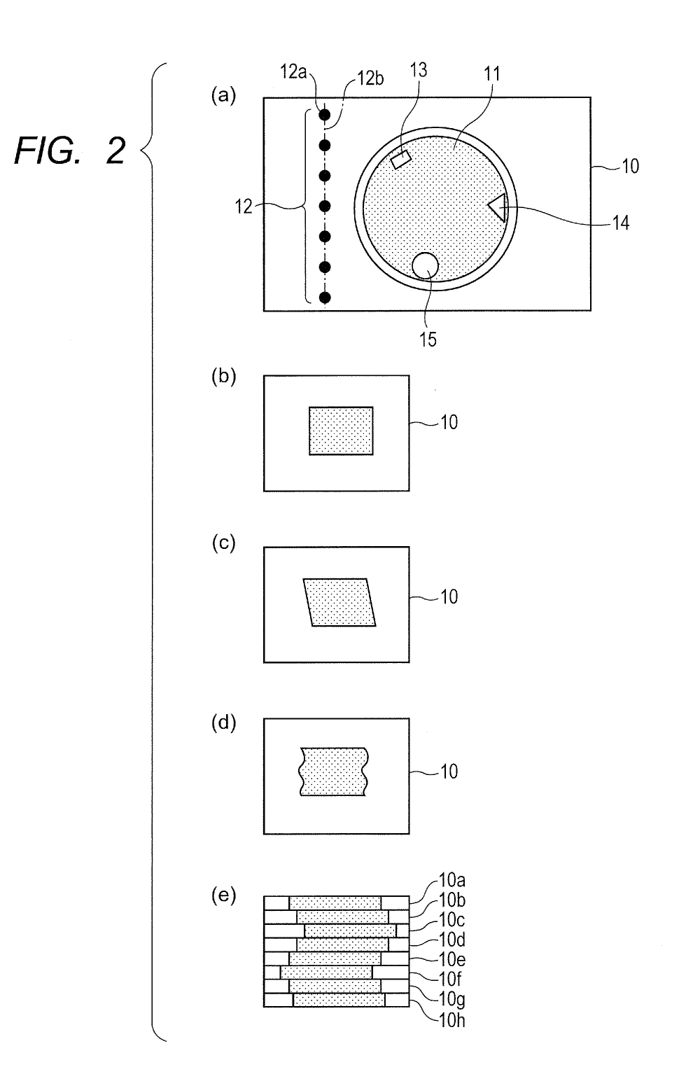

FIG. 1 illustrates an explanatory diagram of an overall configuration of an image measurement apparatus 100 according to a first embodiment of the present invention. FIG. 2 illustrates explanatory diagrams of an image obtained from an image pickup. The image measurement apparatus 100 includes a camera 1 as an image pickup device, a support member 4 for supporting a workpiece 6 as an object to be measured and a controller 50 connected to the camera 1.

The controller 50 is a computer system including a CPU 50a, a ROM 50b, a RAM 50c and an HDD 50d. A program P for operating the CPU 50a is recorded in a memory device such as the ROM 50b or the HDD 50d (the HDD 50d in FIG. 1), and the CPU 50a functions as each unit of a functional block described later by operating based on the program P. That is, in the first embodiment, the CPU 50a functions as a computation processing unit. In the RAM 50c, a calculation result by the CPU 50a and the like are temporarily stored.

The camera 1 is a digital camera that sequentially performs exposure for each line with a rolling shutter system. The camera 1 includes an image sensor 21 having a plurality of pixels, which is a CMOS image sensor for capturing an image of a subject, a controller la that controls the entire camera, and an optical system (not shown) that condenses light from the subject on the image sensor 21. The subject in the first embodiment includes the support member 4 and the workpiece 6.

The plurality of pixels of the image sensor 21 are arranged in a two-dimensional matrix state. An optical signal entering each of the pixels via the optical system (not shown) is converted into an electrical signal in each of the pixels of the image sensor 21. The controller 1a sequentially exposes the pixels of the image sensor 21 for each line in a horizontal scanning direction, thus reading a pixel signal (electrical signal), and sequentially outputs the image signal to the controller 50. The camera 1 is supported to face the workpiece 6 by a pillar 2 that is installed standing on a floor plane so that an image surface of the image sensor 21 and an upper surface of the support member 4 are parallel to each other. A position of each of the pixels of the image sensor 21 is defined with a two-dimensional coordinate system, so that image data of an image, which is an image pickup result, is also defined with the two-dimensional coordinate system.

The support member 4 is a fixed base fixed on the floor plane, and the upper surface thereof makes a plane surface. The workpiece 6 is fixed on the support member 4 by a coupler 5 so that the workpiece 6 does not move.

On the upper surface of the support member 4, a marker group 3 is provided near the workpiece 6 at a position that does not overlap with the workpiece 6. The marker group 3 includes a plurality of markers 3a (circular dots in the first embodiment). The marker group 3 may be drawn in ink on the support member 4 or on an adhesive tape to be attached on the support member 4 or formed by forming a concave portion or a convex portion on the support member 4. In the first embodiment, the marker group 3 is drawn on the support member 4 in ink of a color different from that of the support member 4 (for example, black). The center of each of the dots 3a is taken as a specific position.

As illustrated in (a) of FIG. 2, an image (data) 10 obtained from an image pickup includes a marker group (data) 12 on the two-dimensional coordinate system based on pixels of the image sensor 21, which corresponds to the actual marker group 3. That is, the image (data) 10 includes dots (data) 12a serving as specific positions on the two-dimensional coordinate system and corresponding to the actual dots 3a. The image (data) 10 further includes a workpiece (data) 11 on the two-dimensional coordinate system, which corresponds to the actual workpiece 6, and parts (data) 13, 14 and 15 on the two-dimensional coordinate system, which correspond to actual assembly parts on the workpiece 6.

The plurality of dots 3a of the marker group 3 are arranged on the upper surface of the support member 4 in such a manner that the plurality of dots 12a on the image 10 are spread in a vertical scanning direction, i.e., a longitudinal direction of the image 10 when the image is captured by the image sensor 21 of the camera 1. Specifically, the plurality of dots 3a of the marker group 3 are arranged on the upper surface of the support member 4 in such a manner that a range of the plurality of dots 12a on the image 10 include a range of the workpiece 11 in the vertical scanning direction when the image is captured by the image sensor 21 of the camera 1. The plurality of dots 3a are preferred to be arranged on the support member 4 along the vertical scanning direction on the image. In the first embodiment, the plurality of dots 3a are aligned and arranged on the support member 4 in parallel to the vertical scanning direction on the image. The plurality of dots 3a have a predetermined relative position therebetween, and the dots (data) 12a are stored in the HDD 50d that serves as a memory (memory device).

The dots 3a may be arranged in a random pattern as long as coordinate positions (reference positions) of the plurality of dots 12a spread in the longitudinal direction are known on the two-dimensional coordinate system in an ideal state with no distortion of the image 10. In the first embodiment, the plurality of actual dots 3a are arranged on the upper surface of the support member 4 with a predetermined interval so that the center (i.e., the specific position) of each of the dots 12a is located on an imaginary line 12b on the two-dimensional coordinate system. It is preferred that the imaginary line 12b be parallel to the vertical scanning direction. In the first embodiment, the interval between the dots 3a of the marker group 3 (i.e., the interval between the dots 12a on the image) is known, which is an equal interval in the first embodiment.

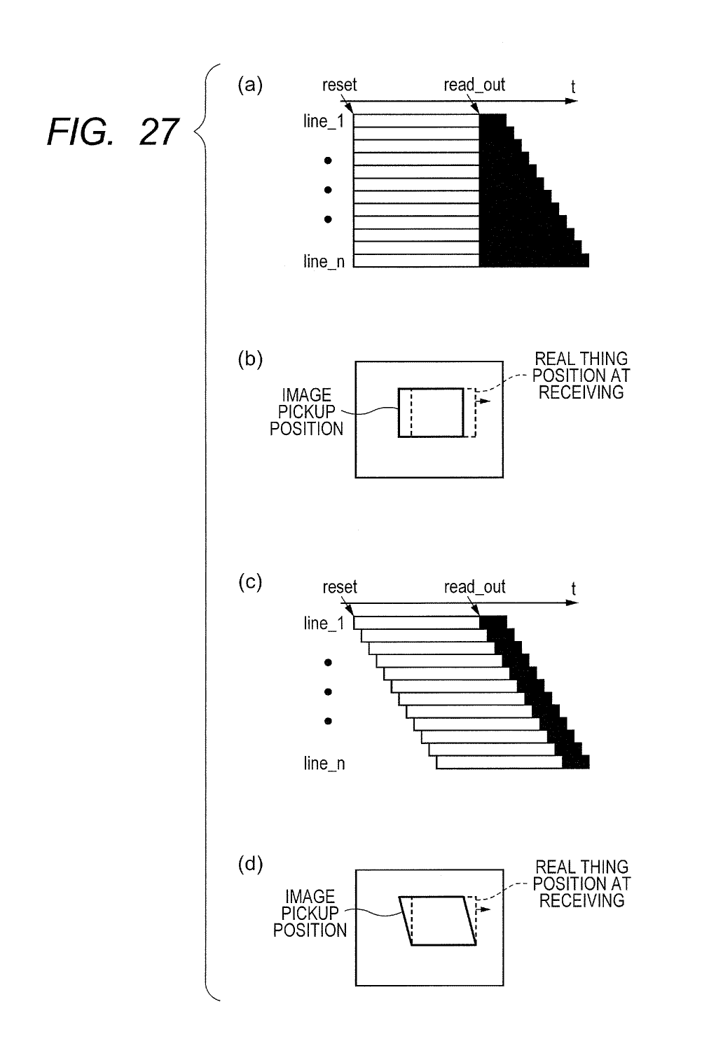

Before describing a configuration for correcting a distortion of an image, factors that cause the image distortion and forms of the image distortion are described. As illustrated in (c) of FIG. 27, the exposure timing is different for each line in the image sensor 21 according to the first embodiment, and hence when an image of the workpiece 6 is captured while the workpiece 6 is moving relative to the camera 1, a position of the workpiece 6 is different at the time to be exposed for each line. For this reason, the workpiece 11 is distorted on the obtained image 10. How the workpiece 11 is distorted on the image 10 is determined by a relation between a direction of the relative movement of the actual workpiece 6 and the vertical and horizontal scanning directions of the camera 1.

(b) of FIG. 2 illustrates an image of the workpiece 6 in a state in which the workpiece 6 remains stationary relative to the camera 1. (c) of FIG. 2 illustrates an image of the workpiece 6 in a state in which the workpiece 6 moved relative to the camera 1 at a constant speed to a right direction on the image, and (d) of FIG. 2 illustrates an image of the workpiece 6 in a state in which the workpiece 6 vibrated relative to the camera 1 to right and left directions on the image. Further, (e) of FIG. 2 illustrates a partially enlarged portion of the image illustrated in (d) of FIG. 2. As illustrated in (e) of FIG. 2, when the workpiece 6 vibrates in the horizontal scanning direction relative to the horizontal scanning direction of the image sensor 21 of the camera 1, in each of lines 10a to 10h, a shift in the horizontal scanning direction (lateral direction) occurs for each line in a manner corresponding to the movement.

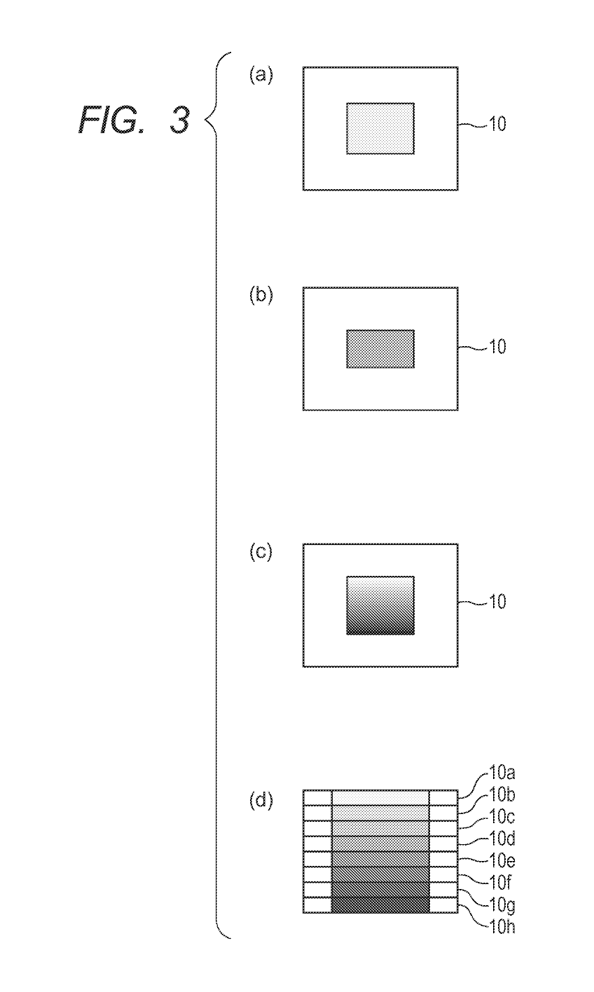

On the other hand, FIG. 3 illustrates forms of distortion occurring when the workpiece 6 makes a parallel movement relative to the vertical scanning direction of the image sensor 21 of the camera 1. (a) of FIG. 3 illustrates an image of the workpiece 6 in a state in which the workpiece 6 remains stationary relative to the camera 1. (b) of FIG. 3 illustrates an image of the workpiece 6 in a state in which the workpiece 6 moved relative to the camera 1 at a constant speed to an upward direction on the image, and (c) of FIG. 3 illustrates an image of the workpiece 6 in a state in which the workpiece 6 vibrated relative to the camera 1 to upward and downward directions on the image. Further, (d) of FIG. 3 illustrates a partially enlarged portion of the image illustrated in (c) of FIG. 3. When the relative movement is in the upward direction, as illustrated in (b) of FIG. 3, such a change occurs that the figure is contracted in the vertical scanning direction of the image 10. On the contrary, when the relative movement is in the downward direction, the figure is expanded. In addition, as illustrated in (c) and (d) of FIG. 3, in a case where there is a change in a speed of the movement, when an image of a workpiece having a uniform intermediate brightness is captured, a coarse and fine state of the image is changed in each of the lines 10a to 10h.

For example, in an assembly work by a robot system or the like, it is necessary to convey an assembly part by a conveying device such as a robot arm, and at this time, the camera 1 and the support member 4 are exposed to a vibration caused by the conveyance device. As a result, a distortion may occur on the captured image 10 as illustrated in (c) to (e) of FIG. 2 or (b) to (d) of FIG. 3.

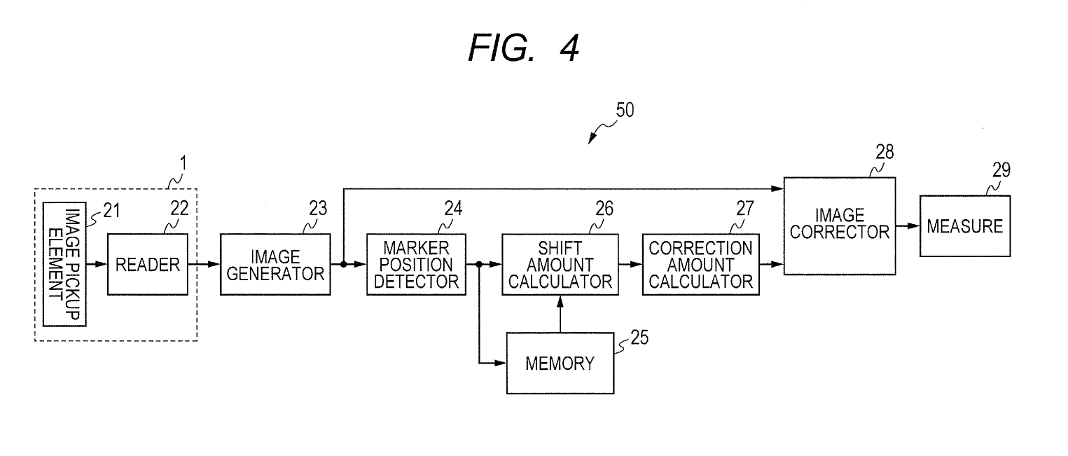

In the first embodiment, the controller 50 measures the position and the shape of the workpiece 6 as a picture of the workpiece 6 by correcting the image 10 in the horizontal scanning direction and the vertical scanning direction. FIG. 4 is a functional block diagram of the camera 1 and the controller 50.

As illustrated in FIG. 4, the camera 1 includes the image sensor 21 and a reader 22. The reader 22 is implemented by the above-mentioned controller 1a. The controller 50 includes an image generator 23, a marker position detector 24, a shift amount calculator 26, a correction amount calculator 27, an image corrector 28 and a measure 29. Specifically, the CPU 50a that operates based on the program P stored in the ROM 50b or the HDD 50d implements the units 23, 24, 26, 27, 28 and 29. The controller 50 further includes a memory 25. The memory 25 is, for example, the HDD 50d. The memory 25 is not limited to the HDD 50d, and may be a non-volatile memory (not shown) (such as an EEPROM) that is rewritable. The memory 25 may be any type of memory device as long as data can be stored and maintained.

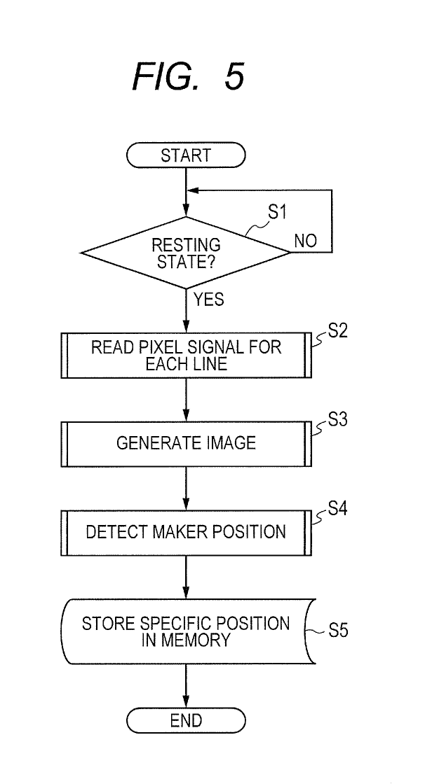

Hereinafter, an operation of each of the units is described below with reference to flowcharts illustrated in FIGS. 5 to 7. An operation of storing a reference position of the marker 12 on the image in the memory 25 before measuring a shape of the workpiece 6 is described with reference to the flowchart illustrated in FIG. 5.

First, the CPU 50a of the controller 50 determines whether or not the camera 1 and the workpiece 6 are in a resting state (Step S1), and when it is determined that the camera 1 and the workpiece 6 are in the resting state, sends a command to perform an image pickup operation to the camera 1. The determination of whether or not the camera 1 and the workpiece 6 are in the resting state may be performed by determining whether or not timing of a predetermined time period by a timer is completed or by determining whether or not a distortion of a captured image has been settled. In this manner, the image measurement apparatus stands by until the camera 1 and the support member 4 are in a sufficient resting state.

Subsequently, the reader 22 sequentially exposes the pixels of the image sensor 21 for each line in the horizontal scanning direction, and reads a pixel signal (Step S2). This operation is the same as the operation described with reference to (c) of FIG. 27. In Step S2, an image pickup of the support member 4 is performed without the workpiece 6. At this time, the dots 12a of the marker 12 on the image 10 are arranged at equal intervals in parallel to the vertical scanning direction.

After that, the image generator 23 generates an image from the pixel signal read by the reader 22 (Step S3). The marker position detector 24 then detects positions of the centers (specific positions) of the dots 12a of the marker 12 on the two-dimensional coordinate system in the image generated by the image generator 23 (Step S4). The circular dots 3a are provided on the support member 4 in the first embodiment, and hence the center position (specific position) can be easily detected with a known image processing method using a Hough transform or the like. The specific position is detected for all the dots 12a.

The CPU 50a stores data of the positions of the centers (specific positions) of the dots 12a detected in the above manner in the memory 25 as data for reference positions (Step S5: storing step). Although the positions are measured from the image in advance and the measured data is stored in the memory 25 in the first embodiment, storing the reference position data is not limited to this scheme, and data representing the positions of the centers of the dots 12a may be stored without performing a measurement of the positions.

Further, in the first embodiment, the dots 12a are arranged at equal intervals on the imaginary line 12b parallel to the vertical scanning direction. Therefore, a coordinate position of the center of any one of the plurality of dots 12a, for example, the dot 12a on the uppermost portion of the image, and a relative position relation of the centers of the other dots 12a with respect to this coordinate position can be stored in the memory 25. In either case, the memory 25 stores therein reference positions of the specific positions corresponding to the centers of the dots 12a of the marker 12 on the two-dimensional coordinate system (i.e., on the image) based on the pixels of the image sensor 21.

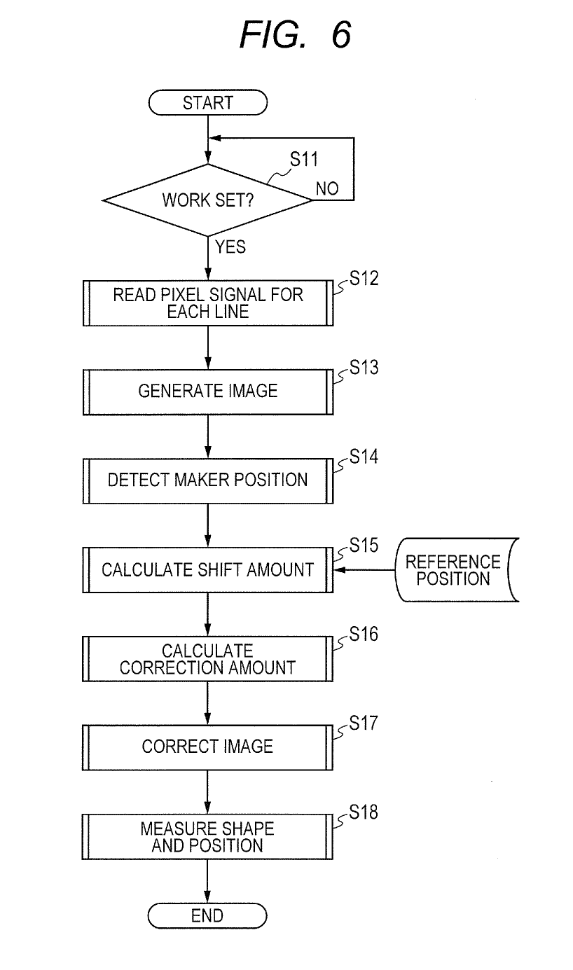

Hereinafter, an operation of measuring a position and a shape of the workpiece 6 as a picture of the workpiece 6 when actually placing the workpiece 6 to perform an assembly work or the like is described with reference to the flowchart illustrated in FIG. 6. First, the CPU 50a of the controller 50 determines whether or not setting of the workpiece 6 on the support member 4 is completed (Step S11). That is, in Step S11, the image measurement apparatus stands by until the workpiece 6 is set on the support member 4 so that the image pickup is ready.

The reader 22 sequentially exposes the pixels of the image sensor 21 for each line in the horizontal scanning direction, and reads a pixel signal (Step S12: reading step). This operation is the same as the operation described with reference to (c) of FIG. 27. At this time of image pickup, one or both of the camera 1 and the support member 4 may move due to a disturbance by a movement of an assembly jig or other tool. That is, the image measurement apparatus does not need to wait until the camera 1 or the support member 4 is in the resting state. Therefore, the time required to measure the workpiece 6 can be shortened.

After that, the image generator 23 generates an image from the pixel signal read by the reader 22 in Step S12 (Step S13: image generating step). The marker position detector 24 then detects positions of the centers (specific positions) of the dots of the marker on the two-dimensional coordinate system in the image generated by the image generator 23 in Step S13 (Step S14: marker position detecting step).

Subsequently, the shift amount calculator 26 reads the data of the reference positions of the specific positions of the marker stored in the memory 25. The shift amount calculator 26 then calculates a difference between the read data of the reference positions and the data of the positions of the specific positions of the marker detected by the marker position detector 24 in Step S14 in the horizontal scanning direction and the vertical scanning direction for each line. That is, the shift amount calculator 26 calculates the difference of each line as a vector amount in the horizontal scanning direction and the vertical scanning direction. The shift amount calculator 26 then calculates a shift amount of each line of the image 10 generated by the image generator 23 in Step S13 by using the result of the difference (Step S15: shift amount calculating step).

After that, the correction amount calculator 27 calculates a correction amount for each line, which cancels the shift amount calculated by the shift amount calculator 26 in Step S15 (Step S16: correction amount calculating step).

Subsequently, the image corrector 28 corrects each line of the image 10 generated by the image generator 23 with the correction amount calculated by the correction amount calculator 27 in Step S16 (Step S17: image correcting step).

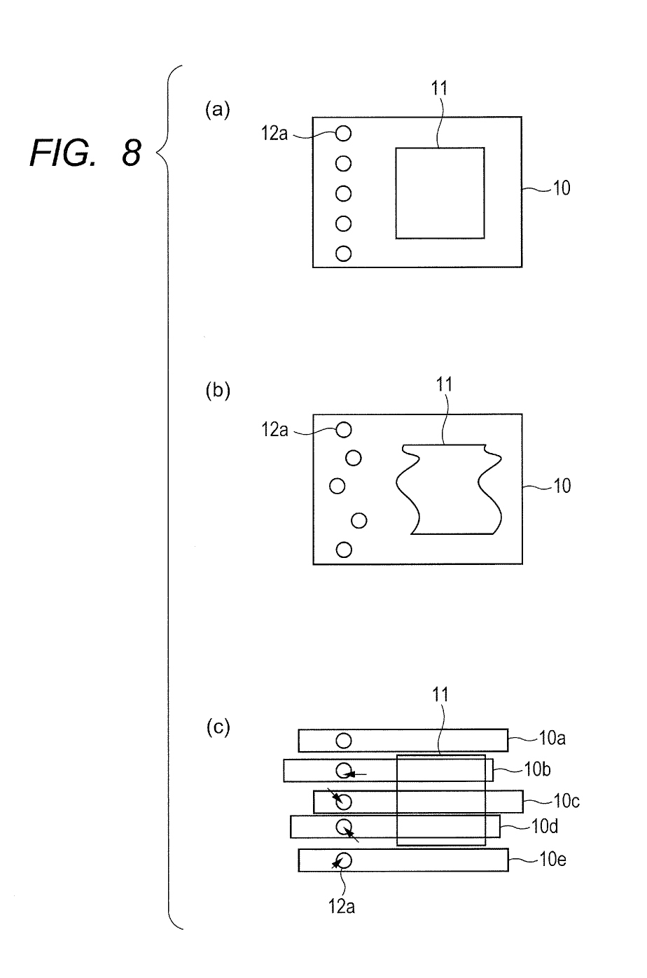

(a) to (c) of FIG. 8 illustrate the above-mentioned steps. (a) of FIG. 8 illustrates an image of the workpiece 6 captured when the workpiece is in the resting state with no distortion in the workpiece 11 on the image 10. Further, the dots 12a of the marker 12 on the image 10 are arranged at equal intervals in the vertical scanning direction. On the other hand, in the image 10 illustrated in (b) of FIG. 8B, which is captured when the workpiece 6 is in a vibrating state in an actual operation, the positional shape of the workpiece 11 is distorted in each line in the lateral and longitudinal directions (horizontal and vertical scanning directions) by being influenced by the vibration due to a difference in the exposure timing.

On the other hand, in Step S16, the correction amount calculator 27 calculates the correction amount (vector amount) indicated by arrows for each of the lines 10a to 10e as illustrated in (c) of FIG. 8, and in Step S17, the image corrector 28 corrects each line of the image in directions of the arrows. That is, coordinate positions of the pixels in each line are corrected by the correction amount. Although only lines having the dots 12a are illustrated in (c) of FIG. 8 for convenience sake, all the lines are corrected in the actual case. As a result, a figure having no distortion can be reproduced as illustrated in (c) FIG. 8.

After that, the measure 29 measures the position and the shape of the workpiece 6 by using the image 10 obtained by correcting the image by the image corrector 28 in Step S17 as a picture of the workpiece 6 (Step S18: measuring step). Specifically, positions and shapes of the parts of the workpiece 6 are measured. With this operation, a picture of the workpiece 6 corrected such that the shift amount is canceled is obtained.

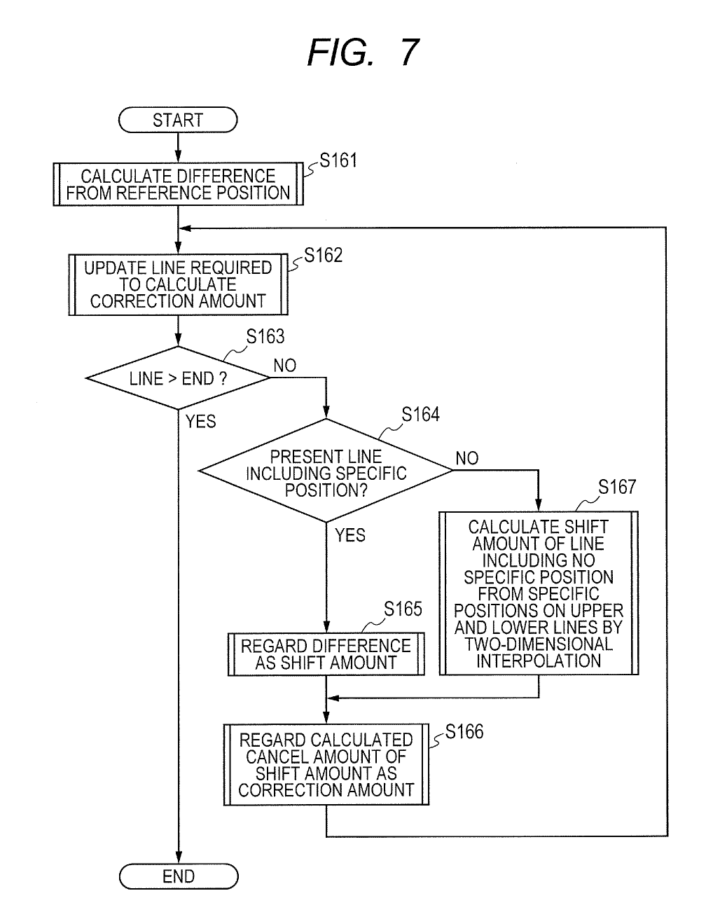

The operations of the shift amount calculator 26 and the correction amount calculator 27 in Steps S15 and S16 are described in detail with reference to the flowchart illustrated in FIG. 7.

First, the shift amount calculator 26 compares pieces of position information of the specific positions on the image and calculates a difference between the measured position and the reference position (Step S161). The shift amount calculator 26 updates a line required to calculate the correction amount such that the lines required to calculate the correction amount are selected from the first line to the last line in a sequential manner (Step S162).

Subsequently, the shift amount calculator 26 determines whether or not correction of all the lines that need to be corrected is completed (Step S163), and when it is determined that the correction is completed (Step S163: YES), ends the operation. When it is determined that the correction is not completed (Step S163: NO), the shift amount calculator 26 determines whether or not the present line includes a specific position (Step S164). When it is determined that the selected line includes a specific position (Step S164: YES), the shift amount calculator 26 regards the difference calculated in Step S161 as the shift amount of the line (Step S165). The correction amount calculator 27 then calculates a correction amount that cancels the shift amount calculated by the shift amount calculator 26 (Step S166).

When it is determined that the selected line includes no specific position (Step S164: NO), the shift amount calculator 26 performs a two-dimensional interpolation from specific positions on the upper and lower lines to calculate the shift amount of the line in the horizontal scanning direction and the vertical scanning direction (Step S167). In this case, a linear interpolation method can be used by using two adjacent upper and lower positions. Alternatively, a spline interpolation may be used by using all upper and lower specific positions. Subsequently, the correction amount calculator 27 calculates a correction amount to cancel the shift amount calculated by the shift amount calculator 26 (Step S166).

As described above, according to the first embodiment, when measuring the position and the shape of the workpiece 6 as a picture of the workpiece 6 by using an image obtained by an image pickup of the image sensor 21, an image distortion can be corrected without using an external sensor such as a gyro sensor. Thus, the position and the shape of the workpiece 6 are obtained by using the image in which the distortion is corrected, and hence the accuracy of measuring the workpiece 6 is enhanced.

In addition, the correction of the image can be performed without using an external sensor, and hence the manufacturing cost can be lowered by the amount of excluding the external sensor and the space can be saved by the amount of excluding the external sensor. Further, none of the camera 1 and the support member 4 needs to include the external sensor and a synchronization circuit for the external sensor is not necessary as well, and hence the overall configuration can be simplified.

### Second Embodiment

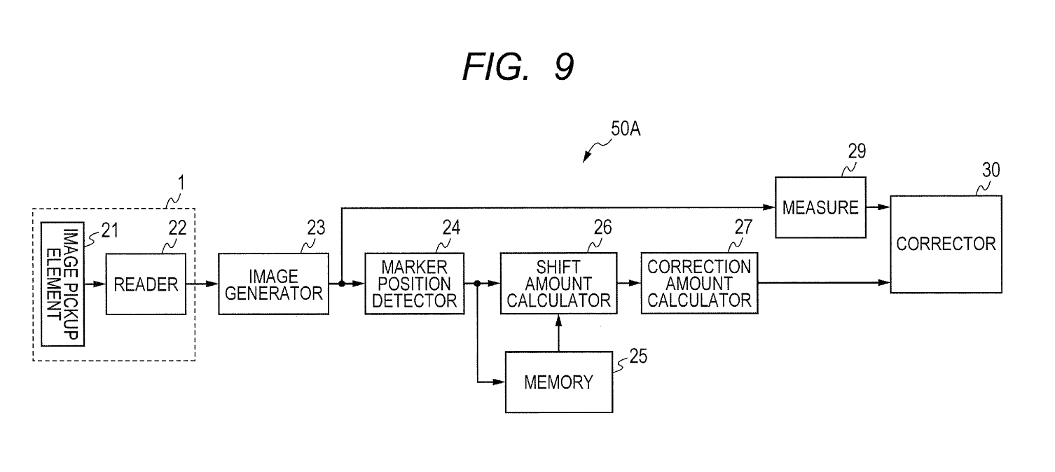

Hereinafter, an image measurement apparatus according to a second embodiment of the present invention is described. FIG. 9 is a functional block diagram of a camera and a controller of the image measurement apparatus according to the second embodiment of the present invention. In FIG. 9, the same structural element as that in the image measurement apparatus according to the above-mentioned first embodiment is assigned with the same reference symbol and a detailed description thereof is omitted.

A controller 50A according to the second embodiment includes an image generator 23, a marker position detector 24, a memory 25, a shift amount calculator 26, a correction amount calculator 27 and a measure 29 in a similar manner as the above-mentioned first embodiment, and further includes a corrector 30.

The controller 50A includes, in the same manner as the above-mentioned first embodiment, includes a CPU 50a, a ROM 50b, a RAM 50c and an HDD 50d as illustrated in FIG. 1. The CPU 50a implements the image generator 23, the marker position detector 24, the shift amount calculator 26, the correction amount calculator 27, the measure 29 and the corrector 30. That is, in the second embodiment, the CPU 50a functions as a computation processing unit.

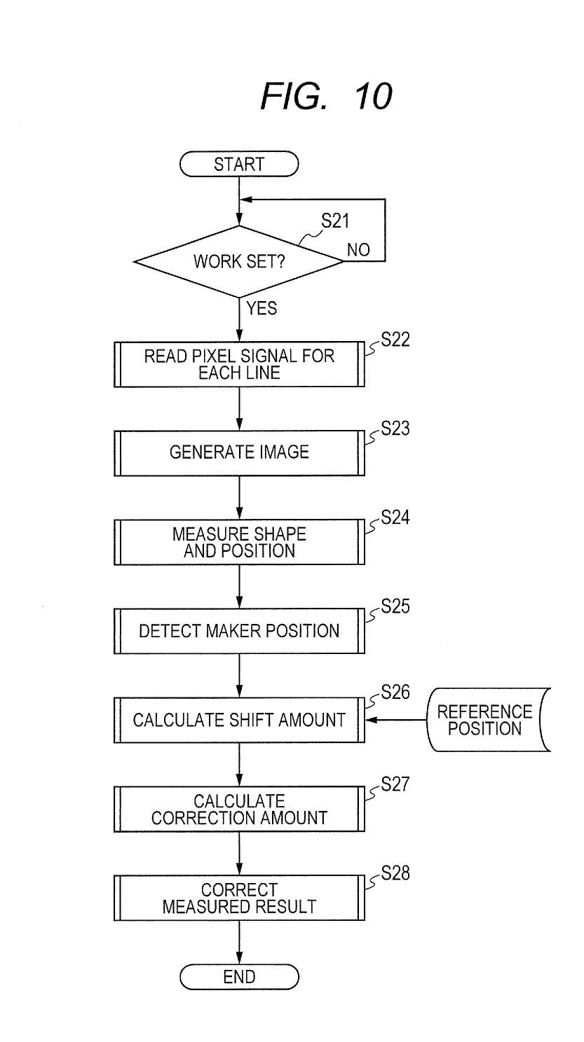

FIG. 10 is a flowchart illustrating an operation when measuring a position and a shape of a workpiece 6 by the camera 1 and the controller 50A. In FIG. 10, processing operations in Steps S21 to S23 are the same as the processing operations in Steps S11 to S13 in FIG. 6, respectively.

In the second embodiment, the measure 29 measures the position and the shape of the workpiece 6 by using an image generated by the image generator 23 in Step S23 (Step S24: measuring step).

Further, processing operations in Steps S25 to S27 are the same as the processing operations in Steps S14 to S16 in FIG. 6, respectively.

The corrector 30 corrects data of the position and the shape of the workpiece 6 measured by the measure 29 in Step S24 by using a correction amount calculated by the correction amount calculator 27 in Step S27 (Step S28: correcting step). The measured data obtained by the measure 29 is corrected with the correction amount for each line. With this operation, a picture of the workpiece 6 that is corrected to cancel the shift amount is obtained.

As described above, according to the second embodiment, the same effect as that of the above-mentioned first embodiment is obtained. That is, a measured result of the position and the shape of the workpiece 6, in which an image distortion is corrected, can be obtained without using an external sensor. Therefore, the accuracy of measuring the position and the shape of the workpiece 6 is enhanced.

In addition, the correction of the image can be performed without using an external sensor, and hence the manufacturing cost can be lowered by the amount of excluding the external sensor and the space can be saved by the amount of excluding the external sensor. Further, none of the camera 1 and the support member 4 needs to include the external sensor and a synchronization circuit for the external sensor is not necessary as well, and hence the overall configuration can be simplified. Moreover, a trouble of reconfiguring the image is saved, and hence there is another advantage in the calculation speed.

Although a case where the plurality of dots 3a are arranged on an image in a direction parallel to the vertical scanning direction is described in the first and second embodiments as an example, the present invention is not limited to this scheme. The effect of the first embodiment cannot be expected when the plurality of dots 3a are arranged in a direction parallel to the horizontal scanning direction, and hence it suffices if the plurality of dots 3a are not arranged in a direction parallel to the horizontal scanning direction on the image. Specifically, the plurality of dots 3a may be arranged to intersect the horizontal scanning direction on the image. At this time, the plurality of dots 3a do not need to be arranged on the same straight line, and can be deviated in the horizontal scanning direction as long as the dots are scattered in the vertical scanning direction.

### Third Embodiment

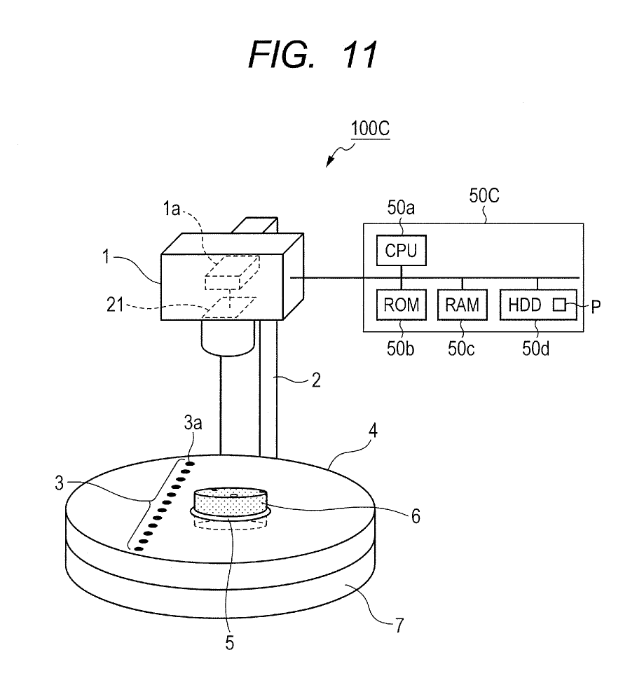

Hereinafter, an image measurement apparatus according to a third embodiment of the present invention is described. FIG. 11 is an explanatory diagram illustrating an overall configuration of an image measurement apparatus 100C according to the third embodiment of the present invention. In FIG. 11, the same structural element as that in the image measurement apparatus according to the above-mentioned first embodiment is assigned with the same reference symbol and a detailed description thereof is omitted.

In the third embodiment, in the same manner as the above-mentioned first embodiment, a marker group 3 is provided on a support member 4 in such a manner that a plurality of dots of the marker group are arranged on an imaginary line on the two-dimensional coordinate system of an image sensor 21 of a camera 1.

The image measurement apparatus 100C according to the third embodiment includes a rotary table 7 as a rotator that rotates the support member 4 in a plane parallel to an image surface of the image sensor 21 in such a manner that the imaginary line becomes parallel to the vertical scanning line on the two-dimensional coordinate system.

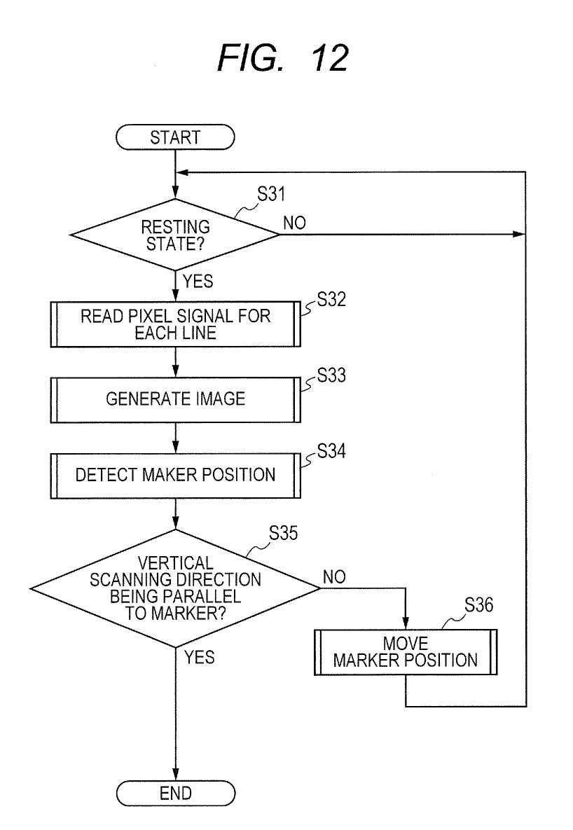

FIG. 12 is a flowchart illustrating an operation performed in advance by the camera 1 and a controller 50C before measuring a shape of a workpiece. In FIG. 12, processing operations in Steps S31 to S34 are the same as the processing operations in Steps S1 to S4 in FIG. 5, respectively.

In the third embodiment, a CPU 50a of the controller 50C determines, after detecting coordinate positions of specific positions on the two-dimensional coordinate system of the image sensor 21 in Step S34, whether or not the vertical scanning direction and the marker are parallel to each other based on the two-dimensional coordinate system of the image sensor 21 (Step S35).

When it is determined that the vertical scanning direction and the marker are not parallel to each other, the CPU 50a rotates the rotary table 7 to move the marker in a direction to make the vertical scanning direction and the marker be parallel to each other in Step S35 (Step S36).

The above-mentioned operations in Steps S31 to S36 are repeated until the vertical scanning direction and the marker become parallel to each other on the two-dimensional coordinate system of the image sensor 21 based on a predetermined reference. This processing eliminates recording of an initial attitude of the marker. That is, a correction value can be obtained in a direct manner from a change of a specific position of the marker in the horizontal and vertical scanning directions.

Further, in the third embodiment, in the same manner as the above-mentioned first embodiment, when measuring the position and the shape of the workpiece 6 by using an image obtained by an image pickup of the image sensor 21, an image distortion can be corrected without using an external sensor such as a gyro sensor. Therefore, the accuracy of measuring the position and the shape of the workpiece 6 is enhanced.

In addition, the correction of the image can be performed without using an external sensor, and hence the manufacturing cost can be lowered by the amount of excluding the external sensor and the space can be saved by the amount of excluding the external sensor. Further, none of the camera 1 and the support member 4 needs to include the external sensor and a synchronization circuit for the external sensor is not necessary as well, and hence the overall configuration can be simplified.

Although a case where the rotator is the rotary table 7 is described in the third embodiment, the present invention is not limited to this scheme, and, for example, the support member may be a robot hand and the rotator may be a robot arm that operates to rotate a workpiece held by the robot hand about an axis line of a camera.

### Fourth Embodiment

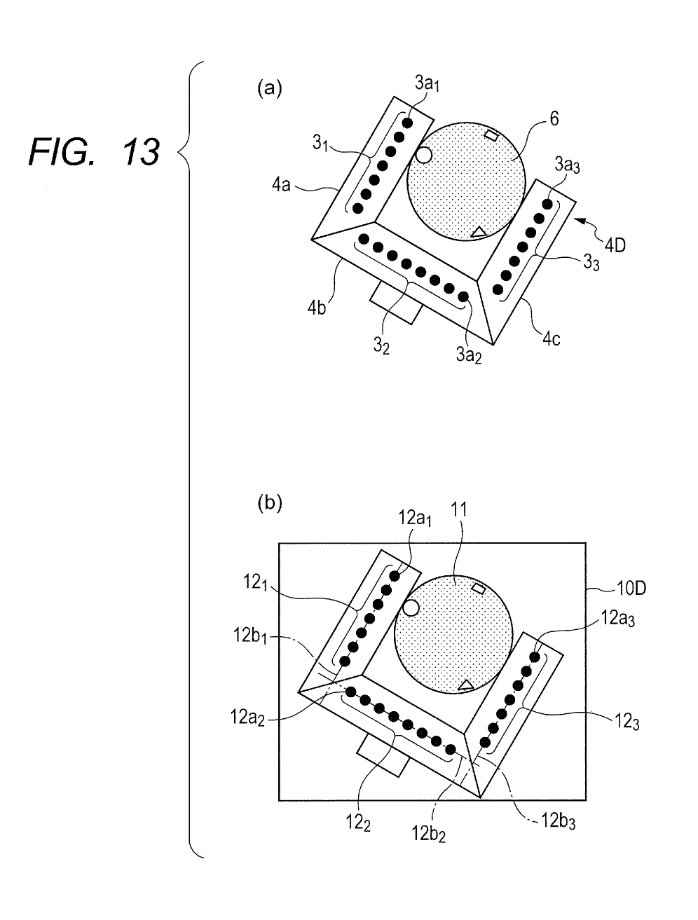

Hereinafter, an image measurement apparatus according to a fourth embodiment of the present invention is described. (a) and (b) of FIG. 13 are diagrams illustrating the image measurement apparatus according to the fourth embodiment of the present invention, in which (a) of FIG. 13 is an explanatory diagram of a support member, and (b) of FIG. 13 is an explanatory diagram illustrating an image obtained by capturing the support member. In (a) and (b) of FIG. 13, the same structural element as that in the image measurement apparatus according to the above-mentioned first embodiment is assigned with the same reference symbol and a detailed description thereof is omitted.

In the fourth embodiment, the support member is a robot hand 4D that includes a fixer 4b and a pair of fingers 4a and 4c that are movable portions that approach or separate to or from each other with respect to the fixer 4b. The robot hand 4D is designed to be mounted on a tip of a robot arm (not shown) in such a manner that the robot hand 4D can freely change its position and attitude. Further, a camera 1 is fixed to a mount member (not shown) that is fixed on a floor plane.

A marker group 3₁ including a plurality of dots 3a₁ arranged with a predetermined interval therebetween is provided on the finger 4a of the robot hand 4D, and a marker group 3₃ including a plurality of dots 3a₃ arranged with a predetermined interval therebetween is provided on the finger 4c. A marker group 3₂ including a plurality of dots 3a₂ arranged with a predetermined interval therebetween is provided on the fixer 4b. That is, a plurality of marker groups are provided on the robot hand 4D.

(b) of FIG. 13 illustrates an image 10D obtained by moving the robot hand 4D to a position facing the camera 1 and performing an image pickup. The image (data) 10D includes marker groups (data) 12₂ to 12₃ on the two-dimensional coordinate system based on the image sensor 21, which correspond to the actual marker groups 3₁ to 3₃, respectively. That is, the image (data) 10D includes dots (data) 12a₁ to 12a₃ serving as specific positions on the two-dimensional coordinate system and corresponding to the actual dots 3a₁ to 3a₃, respectively.

The marker group 3₁ is provided on the finger 4a of the robot hand 4D in such a manner that the dots 12a₁ on the two-dimensional coordinate system of the image sensor 21, which correspond to the plurality of dots 3a₁, are arranged on an imaginary line 12b₁ with a predetermined interval therebetween. The marker group 3₃ is provided on the finger 4c of the robot hand 4D in such a manner that the dots 12a₃ on the two-dimensional coordinate system of the image sensor 21, which correspond to the plurality of dots 3a₃, are arranged on an imaginary line 12b₃ with a predetermined interval therebetween. Further, the marker group 3₂ is provided on the fixer 4b of the robot hand 4D in such a manner that the dots 12a₂ on the two-dimensional coordinate system of the image sensor 21, which correspond to the plurality of dots 3a₂, are arranged on an imaginary line 12b₂ with a predetermined interval therebetween.

In the captured image 10D, the imaginary lines 12b₁ and 12b₂ intersect with each other (intersecting at right angles to each other in (b) of FIG. 13), and the imaginary lines 12b₂ and 12b₃ intersect with each other (intersecting at right angles to each other in (b) of FIG. 13). The actual marker groups 3₁ to 3₃ are arranged in such a manner that the markers do not overlap with each other.

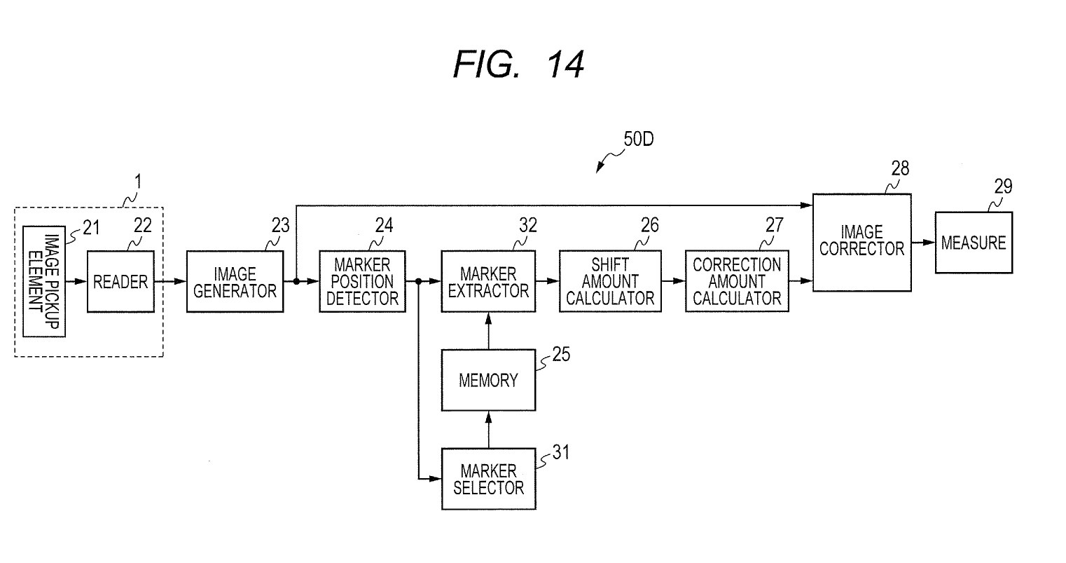

FIG. 14 is a functional block diagram of the camera 1 and a controller 50D. In the fourth embodiment, in the same manner as the above-mentioned first embodiment, the camera 1 includes the image sensor 21 and a reader 22. Further, the controller 50D includes an image generator 23, a marker position detector 24, a marker selector 31, a memory 25, a marker extractor 32, a shift amount calculator 26, a correction amount calculator 27, an image corrector 28 and a measure 29.

The controller 50D includes, in the same manner as the above-mentioned first embodiment, a CPU 50a, a ROM 50b, a RAM 50c and an HDD 50d as illustrated in FIG. 1. The CPU 50a implements the image generator 23, the marker position detector 24, the marker selector 31, the marker extractor 32, the shift amount calculator 26, the correction amount calculator 27, the image corrector 28 and the measure 29. That is, in the fourth embodiment, the CPU 50a functions as a computation processing unit.

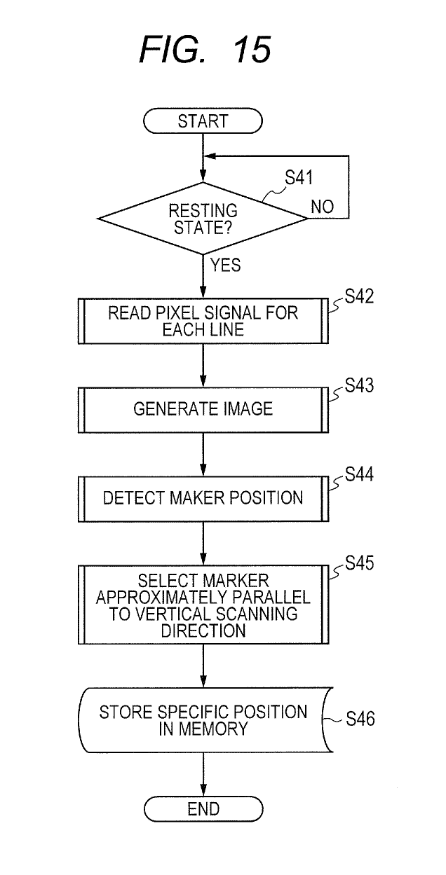

FIG. 15 is a flowchart illustrating an operation performed in advance by the camera 1 and the controller 50D before measuring a shape of a workpiece. In FIG. 15, processing operations in Steps S41 to S43 are the same as the processing operations in Steps S1 to S3 in FIG. 5. The marker position detector 24 detects positions of the plurality (all) of markers 12₁ to 12₃ on the two-dimensional coordinate system based on the image sensor 21 in an image generated by the image generator 23 in Step S43 (Step S44).

Subsequently, the marker selector 31 selects one marker from the plurality of markers 12₁ to 12₃ detected by the marker position detector 24 in Step S44 (Step S45: marker selecting step). At this time, the marker selector selects a marker including a plurality of specific positions arranged on an imaginary line having the lowest parallelism with respect to a line extending in the horizontal scanning direction on the two-dimensional coordinate system. That is, the marker selector 31 selects a marker located on an imaginary line approximately parallel to the vertical scanning direction of the camera, i.e. the longitudinal direction of the image. In FIG. 13, the marker 12₁ including the plurality of dots 12a₁ located on the imaginary line 12b₁ on the image 10D is selected.

When the selected imaginary line is significantly deviated from the vertical scanning direction of the image sensor 21, the correctable range is decreased, so that a correction condition for each line may be changed. However, as the selected imaginary line becomes parallel to the vertical scanning line, a difference of the correction condition between lines is decreased in a broad range, so that a correction result can be obtained in an accurate manner. That is, an appropriate marker is selected from the plurality of markers.

Subsequently, the CPU 50a of the controller 50D stores the marker selected in Step S45 and reference positions of the specific positions of the marker selected in Step S45 in the memory 25 (Step S46: storing step).

Although data of the marker and the reference positions of the specific positions of the marker on the captured image are stored in the memory 25 in the fourth embodiment, the present invention is not limited to this scheme. The marker and the reference positions of the specific positions of the marker on the two-dimensional coordinate system based on the image sensor 21 may be stored in the memory 25 directly without performing the image pickup operation.

In addition, the attitude of the marker can be adjusted with the robot arm, and hence the attitude of any one of the markers may be adjusted to be approximately parallel to the vertical scanning direction of the camera, i.e., the longitudinal direction of the image at the time of issuing an instruction. In this case, recording of an initial attitude of the marker can be eliminated. That is, the correction value can be obtained merely from the relative change between the lines.

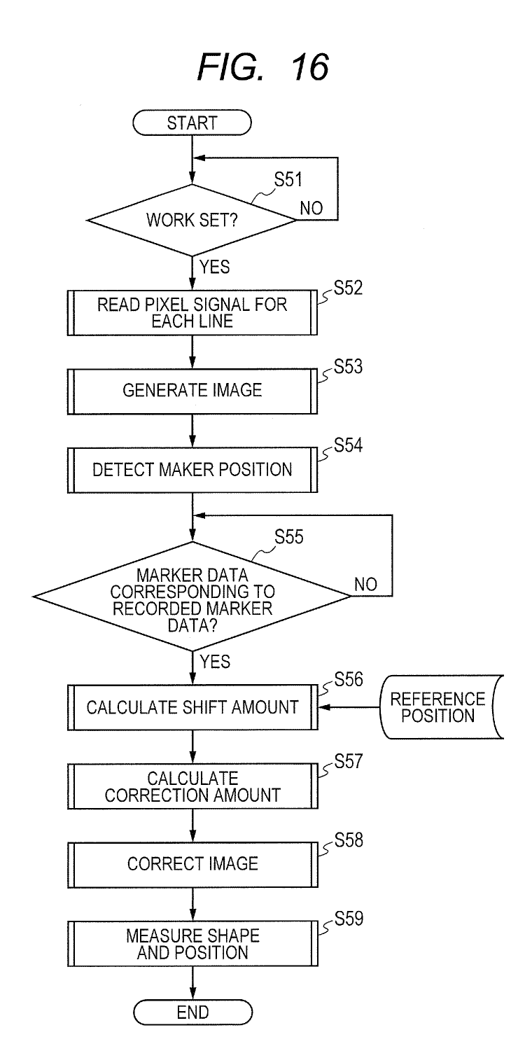

FIG. 16 is a flowchart illustrating an operation when measuring a position and a shape of a workpiece 6 by the camera 1 and the controller 50D. In FIG. 16, processing operations in Steps S51 to S53 are the same as the processing operations in Steps S11 to S13 in FIG. 6. In this case, although the robot arm (not shown) may vibrate, the fingers 4a and 4c of the robot hand 4D need to be stationary so that the workpiece 6 is fixed with respect to the fingers 4a and 4c. The marker position detector 24 then detects positions of the plurality (all) of markers on the two-dimensional coordinate system in an image generated in Step S53 (Step S54: marker position detecting step).

After that, the marker extractor 32 extracts data of markers that correspond to the data of the markers stored in the memory 25 from among the data of the plurality of markers detected by the marker position detector 24 in Step S54 (Step S55: marker extracting step). That is, in Step S55, the detected markers and the recorded markers are compared to determine whether the markers match each other. This can be determined from absolute positions of the markers or predetermined information (in this case, the shape or size of the marker is changed for each of the markers). When the detected markers do not match the recorded markers, Step S55 is repeated again. When the markers can be separated in advance in an obvious manner, Step S54 can be omitted.

Subsequently, the shift amount calculator 26 calculates a shift amount of each line of the image generated by the image generator 23 from differences between the reference positions of the specific positions of the markers stored in the memory 25 and the positions of the specific positions of the markers extracted by the marker extractor 32 in the horizontal scanning direction and the vertical scanning direction (Step S56). The processing operation in Step S56 is the same as the processing operation in Step S15 in FIG. 6. In addition, processing operations in following Steps S57 to S59 are the same as the processing operations in Steps S16 to S18 in FIG. 6.

As described above, in the fourth embodiment, in the same manner as the above-mentioned first embodiment, when measuring the position and the shape of the workpiece 6 by using an image obtained by an image pickup of the image sensor 21, an image distortion can be corrected without using an external sensor such as a gyro sensor. Thus, the position and the shape of the workpiece 6 are obtained by using the image in which the distortion is corrected, and hence the accuracy of measuring the workpiece 6 is enhanced.

In addition, the correction of the image can be performed without using an external sensor, and hence the manufacturing cost can be lowered by the amount of excluding the external sensor and the space can be saved by the amount of excluding the external sensor. Further, none of the camera 1 and the support member 4 needs to include the external sensor and a synchronization circuit for the external sensor is not necessary as well, and hence the overall configuration can be simplified.

Moreover, in the fourth embodiment, the workpiece 6 can be measured even when the robot arm or an assembly member of the camera 1 vibrates, as long as the fingers 4a and 4c of the robot hand 4D are stationary and the workpiece 6 is fixed with respect to the fingers 4a and 4c. Therefore, an operation time can be shortened.

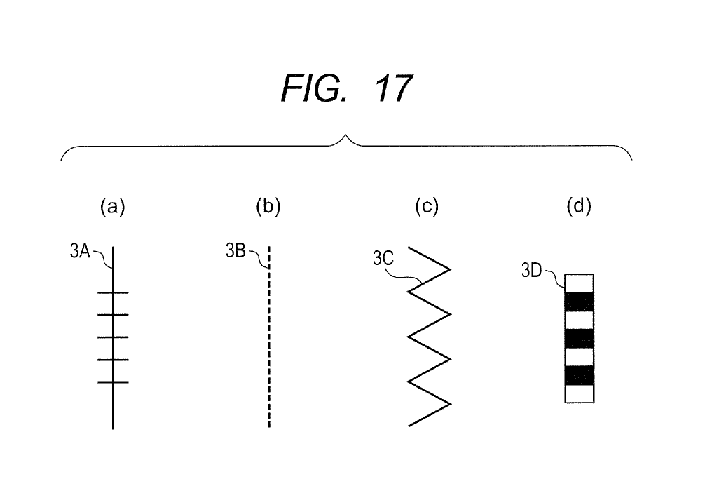

Although a case where the circular dots are arranged in a row along a straight line is described as a marker group in the above-mentioned first to fourth embodiments as an example, the present invention is not limited to this scheme. As long as a plurality of specific positions can be identified and the attitude can be identified with respect to the vertical scanning direction of the camera, any type of marker may be used. For example, as illustrated in (a) of FIG. 17, a marker group 3A including a plurality of markers having cross shapes, which is obtained by combining vertical and horizontal lines, may be used. In this case, an intersection of each cross shape is the specific position. Further, as illustrated in (b) of FIG. 17, a marker group 3B having a broken line shape, in which a plurality of line segment markers are intermittently arranged, may be used. In this case, an end point of each line segment marker is the specific position. Moreover, the plurality of specific positions can also be obtained in a marker group 3C including a plurality of line segment markers intersecting in a sawtooth wave pattern as illustrated in (c) of FIG. 17 and a marker group 3D including a plurality of markers of repeated light and shade as illustrated in (d) of FIG. 17, and the same effect can be obtained therefrom.

### Fifth Embodiment

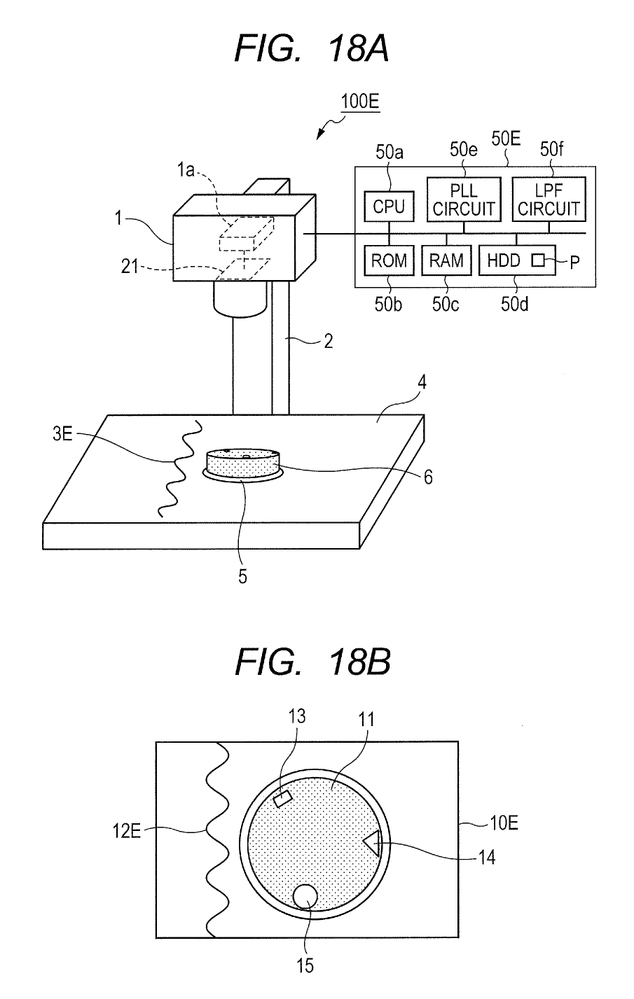

FIGS. 18A and 18B are explanatory diagrams respectively illustrating an overall configuration of an image measurement apparatus and an image obtained from an image pickup according to a fifth embodiment of the present invention. An image measurement apparatus 100E includes a camera 1 as an image pickup device, a support member 4 for supporting a workpiece 6 as an object to be measured, and a controller 50E connected to the camera 1.

The controller 50E is a computer system including a CPU 50a, a ROM 50b, a RAM 50c, an HDD 50d, a phase locked loop circuit (PLL circuit) 50e and a low pass filter circuit (LPF circuit) 50f. A program P for operating the CPU 50a is recorded in a memory device such as the ROM 50b or the HDD 50d (the HDD 50d in FIG. 18A), and the CPU 50a functions as each unit of a functional block described later by operating based on the program P. In the RAM 50c, a calculation result by the CPU 50a and the like are temporarily stored. The PLL circuit 50e extracts a frequency modulation component for a reference frequency of a waveform from input waveform data. The LPF circuit 50f extracts only a necessary band component from output waveform data from the PLL circuit 50e. That is, in the fifth embodiment, the CPU 50a, the PLL circuit 50e, and the LPF circuit 50f function as a computation processing unit.

The camera 1 is a digital camera that sequentially performs exposure for each line with a rolling shutter system. The camera 1 includes an image sensor 21 having a plurality of pixels, which is a CMOS image sensor for capturing an image of a subject, a controller 1a that controls the entire camera, and an optical system (not shown) that condenses light from the subject on the image sensor 21. The subject in the fifth embodiment includes the support member 4 and the workpiece 6.

The plurality of pixels of the image sensor 21 are arranged in a two-dimensional matrix state. An optical signal entering each of the pixels via the optical system (not shown) is converted into an electrical signal in each of the pixels of the image sensor 21. The controller 1a sequentially exposes the pixels of the image sensor 21 for each line in a horizontal scanning direction, thus reading a pixel signal (electrical signal), and sequentially outputs the image signal to the controller 50E. The camera 1 is supported to face the workpiece 6 by a pillar 2 that is installed standing on a floor plane so that an image surface of the image sensor 21 and an upper surface of the support member 4 are parallel to each other. A position of each of the pixels of the image sensor 21 is defined with a two-dimensional coordinate system, so that image data of an image, which is an image pickup result, is also defined with the two-dimensional coordinate system.

The support member 4 is a fixed base fixed on the floor plane, and the upper surface thereof makes a plane surface. The workpiece 6 is fixed on the support member 4 by a coupler 5 so that the workpiece 6 does not move.

On the upper surface of the support member 4, a marker 3E is provided near the workpiece 6 at a position that does not overlap with the workpiece 6. The marker 3E is a sinusoidal curve having an amplitude in the horizontal scanning direction. The marker 3E may be drawn in ink on the support member 4 or on an adhesive tape to be attached on the support member 4 or formed by forming a groove or a protrusion on the support member 4. In the fifth embodiment, the marker 3E is drawn on the support member 4 in ink of a color different from that of the support member 4 (for example, black).

As illustrated in FIG. 18B, an image (data) 10E obtained from an image pickup includes a marker (data) 12E on the two-dimensional coordinate system based on pixels of the image sensor 21, which corresponds to the actual marker 3E. The image (data) 10E further includes a workpiece (data) 11 on the two-dimensional coordinate system, which corresponds to the actual workpiece 6, and parts (data) 13, 14 and 15 on the two-dimensional coordinate system, which correspond to actual assembly parts on the workpiece 6.

The marker 3E is arranged on the upper surface of the support member 4 to extend in a direction parallel to the vertical scanning direction, i.e., the longitudinal direction of the image 10E when the image is captured by the image sensor 21 of the camera 1. Specifically, the marker 3E is arranged on the upper surface of the support member 4 in such a manner that a range of the marker 12E on the image 10E includes a range of the workpiece 11 in the vertical scanning direction when the image is captured by the image sensor 21 of the camera 1.

The marker 3E is arranged on the upper surface of the support member 4 so as to extend in the vertical scanning direction on the two-dimensional coordinate system in an ideal state with no distortion of the image 10E. Further, the marker 3E has the amplitude of the sinusoidal wave in the horizontal scanning direction on the two-dimensional coordinate system of the image sensor 21. It is assumed that a spatial frequency of the marker 3E is known. That is, data of the spatial frequency of the marker 3E is stored in the HDD 50d that serves as a memory (memory device). The spatial frequency of the marker 3E is selected to be two times or more higher than a distortion frequency on the image, which is to be removed by a correction.

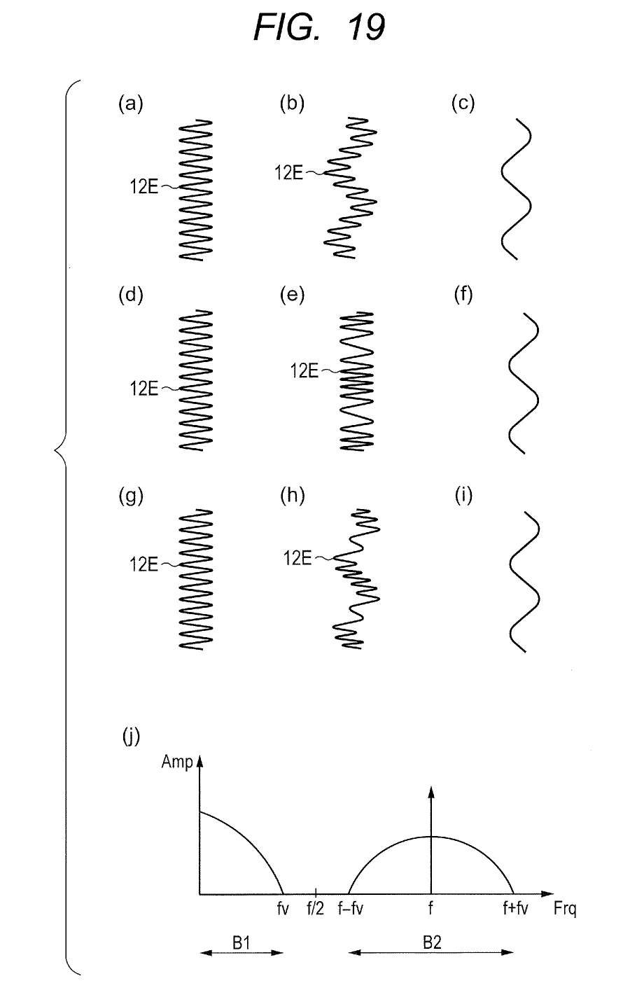

First, a change occurring in the marker 3E when there is a relative movement between the camera 1 and the support member 4 that is a subject in the fifth embodiment is described. (a) to (j) of FIG. 19 are diagrams illustrating waveforms of the marker on the image. (a) of FIG. 19 illustrates a waveform of the marker 12E on the image captured in a state in which there is no vibration, and (b) of FIG. 19 illustrates a waveform of the marker 12E on the image captured in a state in which there is a relative vibration in the same direction as the horizontal scanning direction of the camera. Further, (c) of FIG. 19 illustrates a waveform of a vibration frequency component when there is a relative vibration in the same direction as the horizontal scanning direction of the camera. The waveform of the marker 12E illustrated in (b) of FIG. 19 is a sum of the waveform of the marker 12E illustrated in (a) of FIG. 19 and the waveform of the vibration frequency component illustrated in (c) of FIG. 19. A correction is obtained by extracting the waveform illustrated in (c) of FIG. 19 from the waveform illustrated in (b) of FIG. 19 and restoring the waveform illustrated in (a) of FIG. 19.

(d) of FIG. 19 illustrates a waveform of the marker 12E on the image captured in a state in which there is no vibration, and (e) of FIG. 19 illustrates a waveform of the marker 12E on the image captured in a state in which there is a relative vibration in the same direction as the vertical scanning direction of the camera. Further, (f) of FIG. 19 illustrates a waveform of a vibration frequency component when there is a relative vibration in the same direction as the vertical scanning direction of the camera. The waveform of the marker 12E illustrated in (e) of FIG. 19 is a waveform in which a condensation and rarefaction of the waveform of the marker 12E illustrated in (d) of FIG. 19 is changed with a period of the waveform illustrated in (f) of FIG. 19, i.e., the frequency of the waveform illustrated in (d) of FIG. 19 is modulated with the oscillation waveform illustrated in (f) of FIG. 19. Also in this case, a correction is obtained by extracting the waveform illustrated in (f) of FIG. 19 from the waveform illustrated in (e) of FIG. 19 and restoring the waveform illustrated in (d) of FIG. 19.

(g) of FIG. 19 illustrates a waveform of the marker 12E on the image captured in a state in which there is no vibration and (h) of FIG. 19 illustrates a waveform of the marker 12E on the image captured in a state in which there is a relative vibration in both the horizontal scanning direction and the vertical scanning direction of the camera. Further, (i) of FIG. 19 illustrates a waveform of a vibration frequency component when there is a relative vibration in both the horizontal scanning direction and the vertical scanning direction of the camera. In this case, the changed waveform to be captured has a combination of the change in the lateral direction and a condensation and rarefaction of the waveform. A correction can be obtained in any case as long as the waveform illustrated in (g) of FIG. 19 can be reproduced from the waveform illustrated in (h) of FIG. 19.

A spatial frequency of the actual marker waveform is set to f, and the maximum spatial frequency of a distortion (vibration) to be removed (estimated) is set to fv. The spatial frequency f is set to be two times or more higher than the spatial frequency fv. While the vibration component to be removed in the horizontal scanning direction in (c) of FIG. 19 is the frequency fv or lower, the frequency modulation component to be removed in (f) of FIG. 19 is f−fv to f+fv. Therefore, because f−fv>2fv−fv=fv is satisfied, when the spatial frequency f is set to a value two times or more larger than the spatial frequency fv, the influence can be extracted separately in the horizontal scanning direction and the vertical scanning direction. This is illustrated in (j) of FIG. 19. (j) of FIG. 19 is a diagram illustrating a frequency distribution of the marker waveform at the time of measurement. In (j) of FIG. 19, the vertical axis represents amplitude of the vibration component, and the horizontal axis represents frequency. The distortion component in the horizontal scanning direction is included in an area (frequency band) B1 and the distortion component in the vertical scanning direction is included in an area (frequency band) B2, and hence the distortion components in the horizontal scanning direction and the vertical scanning direction can be easily separated.

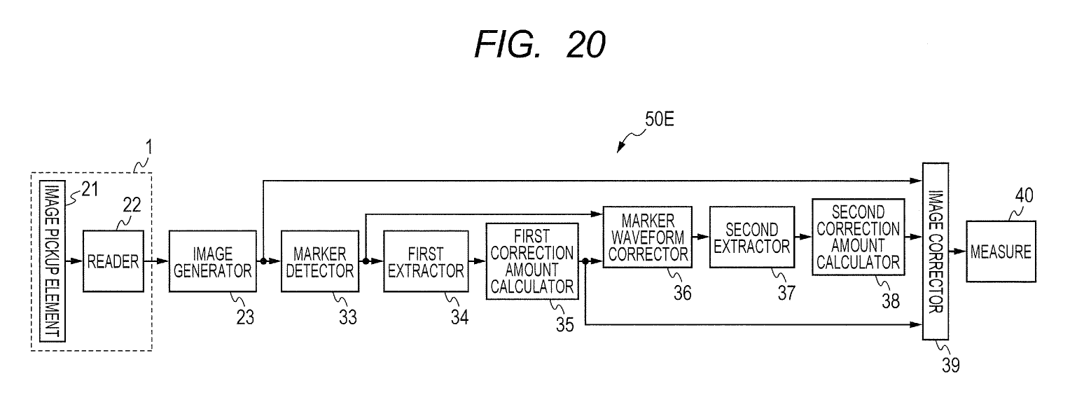

FIG. 20 is a functional block diagram of the camera 1 and the controller 50E. As illustrated in FIG. 20, the camera 1 includes the image sensor 21 and a reader 22. The reader 22 is implemented by the above-mentioned controller 1a. The controller 50E includes an image generator 23, a marker detector 33, a first extractor 34, a first correction amount calculator 35, a marker waveform corrector 36, a second extractor 37, a second correction amount calculator 38, an image corrector 39, and a measure 40. Specifically, the second extractor 37 includes the PLL circuit 50e and the LPF circuit 50f which are illustrated in FIG. 18A, the LPF circuit 50f extracting only the necessary band component from an output of the PLL circuit 50e. Further, the CPU 50a that operates based on a program P stored in the ROM 50b or the HDD 50d implements the units 23 to 35 and 37 to 39.

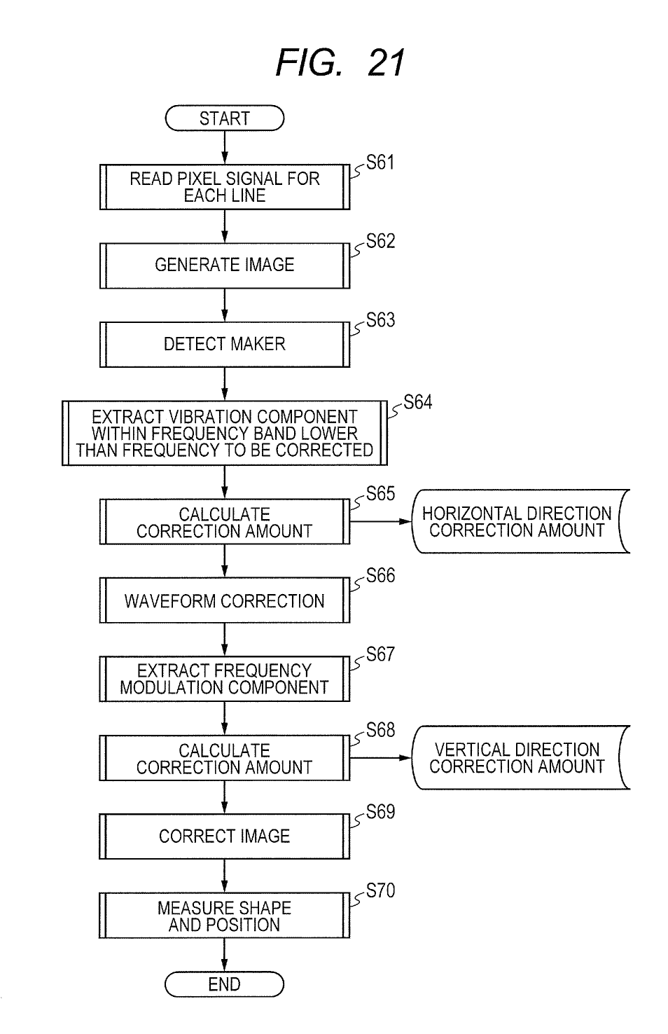

Hereinafter, an operation of each of the units is described below with reference to a flowchart illustrated in FIG. 21. The reader 22 sequentially exposes the pixels of the image sensor 21 for each line in the horizontal scanning direction, and reads a pixel signal (Step S61: reading step). This operation is the same as the operation described with reference to FIG. (c) of 27. At this time of image pickup, one or both of the camera 1 and the support member 4 may move due to a disturbance by a movement of an assembly jig or other tool. That is, the image measurement apparatus does not need to wait until the camera 1 or the support member 4 is in the resting state. Therefore, the time required to measure the workpiece 6 can be shortened.

After that, the image generator 23 generates an image from the pixel signal read by the reader 22 in Step S61 (Step S62: image generating step). The marker detector 33 then detects a waveform of the marker in the image generated by the image generator 23 in Step S62 (Step S63: marker detecting step).

Subsequently, the first extractor 34 extracts a vibration component within the frequency band B1 of a value smaller than a half of the spatial frequency f from the waveform of the marker detected by the marker detector in Step S63 ((j) of FIG. 19) (Step S64: first extracting step). Specifically, the spatial frequency f of the marker waveform is set to a value two times or more larger than the maximum spatial frequency fv of the estimated vibration (i.e., stored in the HDD 50d). Therefore, as illustrated in (j) of FIG. 19, the spatial frequency fv is in an area lower than a half of the spatial frequency f of the marker waveform. That is, the vibration component in the horizontal scanning direction is in the frequency band B1, and the vibration component in this frequency band B1 is extracted. The upper limit of the frequency band B1 is the spatial frequency fv, and the lower limit is zero.

After that, the first correction amount calculator 35 calculates a first correction amount in the horizontal scanning direction for each line, which cancels the vibration component extracted by the first extractor in Step S64 (Step S65: first correction amount calculating step). This first correction amount is stored in the memory (HDD 50d) by the CPU 50a.

Subsequently, the marker waveform corrector 36 corrects the marker waveform detected by the marker detector 33 in Step S63 with the first correction amount in the horizontal scanning direction for each line (Step S66: marker waveform correcting step). Through correction of the detected marker waveform as described above, the vibration component in the horizontal scanning direction is removed from the marker waveform illustrated in (h) of FIG. 19, so that the marker waveform illustrated in (h) of FIG. 19 becomes the marker waveform illustrated in (e) of FIG. 19.

After that, the second extractor 37 extracts a frequency modulation component of the marker waveform that has been corrected by the marker waveform corrector 36 in Step S66 (Step S67: second extracting step). That is, the marker waveform corrected by the marker waveform corrector 36 includes the frequency modulation component superimposed on the waveform of the spatial frequency f that is the reference frequency as a vibration component in the vertical scanning direction, and hence this superimposed vibration component in the vertical scanning direction is extracted. The second extractor 37 includes hardware including the PLL circuit 50e and the LPF circuit 50f for demodulating the frequency modulation component. The hardware loads the waveform data as digital data, and hence the processing is executed by a known method using software.

Subsequently, the second correction amount calculator 38 calculates a second correction amount in the vertical scanning direction for each line, which cancels the frequency modulation component extracted by the second extractor 37 in Step S67 (Step S68: second correction amount calculating step). This second correction amount is stored in the memory (HDD 50d) by the CPU 50a.

After that, the image corrector 39 corrects the image generated by the image generator 23 in the horizontal scanning direction for each line with the first correction amount and in the vertical scanning direction for each line with the second correction amount (Step S69: image correcting step). Subsequently, the measure 40 measures the position and the shape of the workpiece 6 by using the image obtained from the correction by the image corrector 39 in Step S69 as a picture of the workpiece 6 (Step S70: measuring step). With this operation, a picture of the workpiece 6 that is corrected with the first correction amount and the second correction amount is obtained.

As described above, according to the fifth embodiment, in the same manner as the above-mentioned first embodiment, when measuring the position and the shape of the workpiece 6 by using an image obtained by an image pickup of the image sensor 21 as a picture of the workpiece 6, an image distortion can be corrected without using an external sensor such as a gyro sensor. Thus, the position and the shape of the workpiece 6 are obtained by using the image in which the distortion is corrected, and hence the accuracy of measuring the workpiece 6 is enhanced.

In addition, the correction of the image can be performed without using an external sensor, and hence the manufacturing cost can be lowered by the amount of excluding the external sensor and the space can be saved by the amount of excluding the external sensor. Further, none of the camera 1 and the support member 4 needs to include the external sensor and a synchronization circuit for the external sensor is not necessary as well, and hence the overall configuration can be simplified.

Although a case of the marker 3E having the amplitude in the horizontal scanning direction is described in the fifth embodiment as an example, the same effect can be achieved even when a marker having a sinusoidal shape which has change of a condensation and rarefaction of a waveform in the vertical scanning direction is used.

### Sixth Embodiment

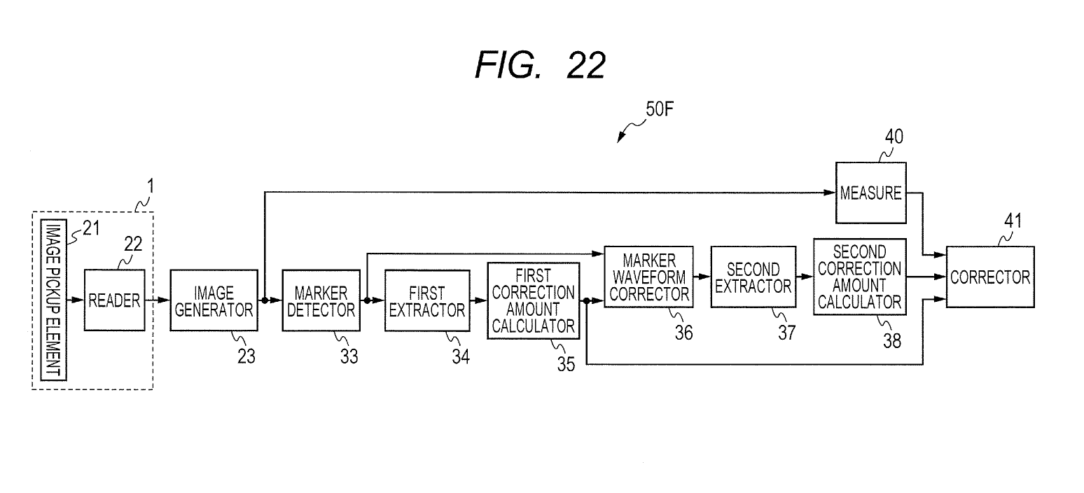

Hereinafter, an image measurement apparatus according to a sixth embodiment of the present invention is described. FIG. 22 is a functional block diagram of a camera and a controller of the image measurement apparatus according to the sixth embodiment of the present invention. In FIG. 22, the same structural element as that in the image measurement apparatus according to the above-mentioned fifth embodiment is assigned with the same reference symbol and a detailed description thereof is omitted.

A controller 50F according to the sixth embodiment includes, in the same manner as the above-mentioned fifth embodiment, an image generator 23, a marker detector 33, a first extractor 34, a first correction amount calculator 35, a marker waveform corrector 36, a second extractor 37, a second correction amount calculator 38 and a measure 40. The controller 50F further includes a corrector 41.

The controller 50F includes, in the same manner as the above-mentioned fifth embodiment, a CPU 50a, a ROM 50b, a RAM 50c, an HDD 50d, a PLL circuit 50e and a LPF circuit 50f as illustrated in FIG. 18A. The CPU 50a functions as the image generator 23, the marker detector 33, the first extractor 34, the first correction amount calculator 35, the marker waveform corrector 36, the second correction amount calculator 38, the measure 40 and the corrector 41. The PLL circuit 50e and the LPF circuit 50f function as the second extractor 37. In the sixth embodiment, the CPU 50a, the PLL circuit 50e and the LPF circuit 50f function as a computation processing unit.

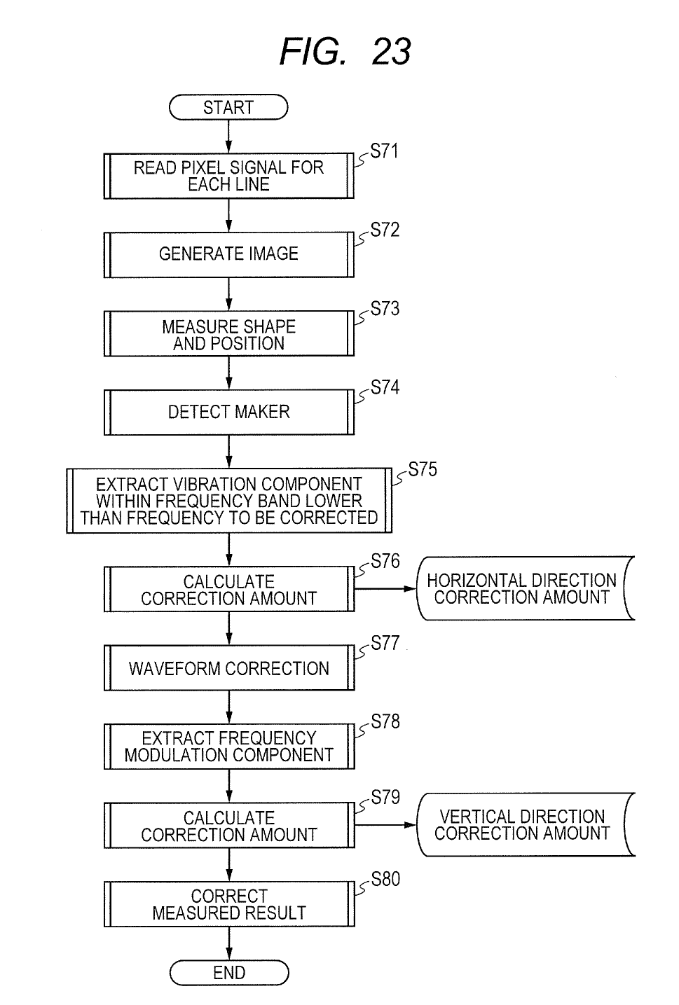

FIG. 23 is a flowchart illustrating an operation when measuring a position and a shape of a workpiece 6 by the camera 1 and the controller 50F. In FIG. 23, processing operations in Steps S71 and S72 are the same as the processing operations in Steps S61 and S62 in FIG. 21.

In the sixth embodiment, the measure 40 measures the position and the shape of the workpiece 6 by using an image generated by the image generator 23 in Step S72 (Step S73: measuring step).

Further, processing operations in Steps S74 to S79 are the same as the processing operations in Steps S63 to S68 in FIG. 21.

After completing the processing of Step S79, the corrector 41 corrects data of the position and the shape measured by the measure 40 in Step S73 in the horizontal scanning direction for each line with the first correction amount and in the vertical scanning direction for each line with the second correction amount (Step S80: correcting step). With this operation, a picture of the workpiece 6 that is corrected with the first correction amount and the second correction amount is obtained.

As described above, according to the sixth embodiment, the same effect as that in the above-mentioned fifth embodiment can be obtained. That is, a measured result of the position and the shape of the workpiece 6 with an image distortion corrected can be obtained without using an external sensor. Therefore, the accuracy of measuring the position and the shape of the workpiece 6 is enhanced.

In addition, the correction of the image can be performed without using an external sensor, and hence the manufacturing cost can be lowered by the amount of excluding the external sensor and the space can be saved by the amount of excluding the external sensor. Further, none of the camera 1 and the support member 4 needs to include the external sensor and a synchronization circuit for the external sensor is not necessary as well, and hence the overall configuration can be simplified. Moreover, a trouble of reconfiguring the image is saved, and hence there is another advantage in the calculation speed. Further, the correction can be performed with accuracy on the sub-pixel level, and hence a correction with even higher accuracy can be obtained.

Although a case where the marker 3E extends in a direction parallel to the vertical scanning direction on the image is described in the above-mentioned fifth and sixth embodiments as an example, the present invention is not limited to this scheme, and the marker may extend in any direction as long as the direction is not parallel to the horizontal scanning direction. Specifically, the marker 3E may be arranged to intersect the horizontal scanning direction on the image.

### Seventh Embodiment

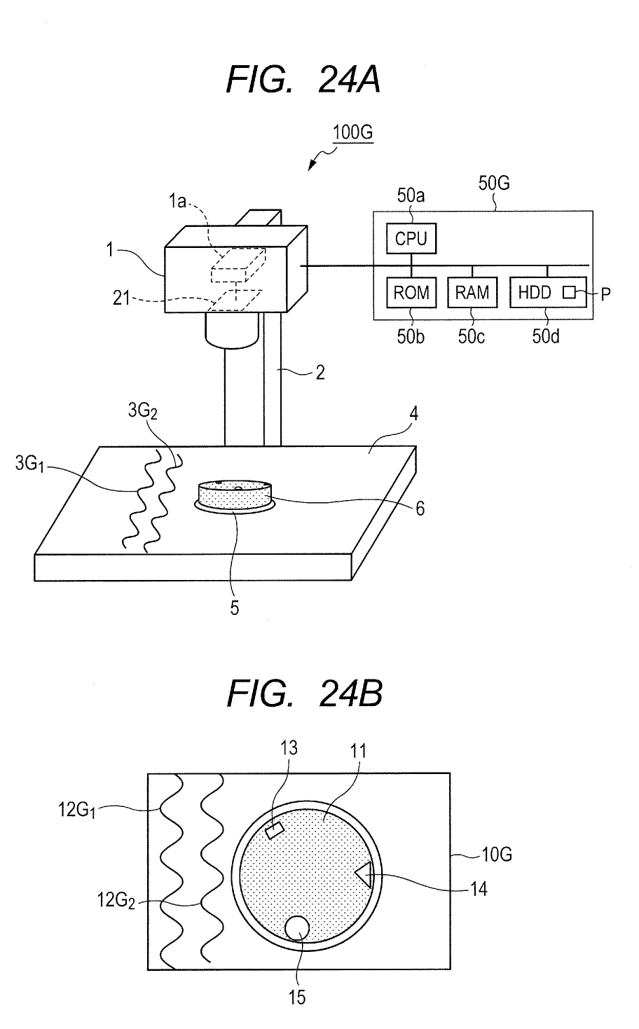

An image measurement apparatus according to a seventh embodiment of the present invention is described below. FIGS. 24A and 24B are explanatory diagrams respectively illustrating an overall configuration of the image measurement apparatus and an image obtained from an image pickup according to the seventh embodiment of the present invention. In FIGS. 24A and 24B, the same structural element as that in the image measurement apparatus according to the above-mentioned fifth embodiment is assigned with the same reference symbol and a detailed description thereof is omitted.

As illustrated in FIG. 24A, an image measurement apparatus 100G includes a camera 1 as an image pickup device, a support member 4 for supporting a workpiece 6 as an object to be measured and a controller 50G connected to the camera 1.

The controller 50G is a computer system including a CPU 50a, a ROM 50b, a RAM 50c and an HDD 50d. A program P for operating the CPU 50a is recorded in a memory device such as the ROM 50b or the HDD 50d (the HDD 50d in FIG. 24A), and the CPU 50a functions as each unit of a functional block described later by operating based on the program P. In the RAM 50c, a calculation result by the CPU 50a and the like are temporarily stored. In the seventh embodiment, the CPU 50a functions as a computation processing unit.

On the upper surface of the support member 4 according to the seventh embodiment, there are provided a first marker 3G₁ having a sinusoidal shape which has a known spatial frequency f and a second marker 3G₂ having a cosine-wave shape which has a phase difference of 90° with respect to the first marker 3G₁.

As illustrated in FIG. 24B, an image (data) 10G obtained from an image pickup includes markers (data) 12G₁ and 12G₂ on the two-dimensional coordinate system based on the pixels of the image sensor 21, which correspond to the actual markers 3G₁ and 3G₂, respectively. The image (data) 10G further includes a workpiece (data) 11 on the two-dimensional coordinate system, which corresponds to the actual workpiece 6, and parts (data) 13, 14 and 15 on the two-dimensional coordinate system, which correspond to actual assembly parts on the workpiece 6, respectively.

Those markers 3G₁ and 3G₂ are arranged on the support member 4 so as to extend in a direction parallel to the vertical scanning direction on the two-dimensional coordinate system of the image sensor 21, i.e., so that the markers 12G₁ and 12G₂ extend in a direction parallel to the vertical scanning direction (longitudinal direction) on the image 10G illustrated in FIG. 24B. Further, the markers 3G₁ and 3G₂ have amplitudes in the horizontal scanning direction (lateral direction) based on the two-dimensional coordinate system of the image sensor 21. Moreover, spatial frequencies of the sinusoidal wave and the cosine wave of the markers 3G₁ and 3G₂ are the same and are known values in advance. That is, data of the spatial frequencies of the markers 3G₁ and 3G₂ are stored in the HDD 50d that serves as a memory (memory device).

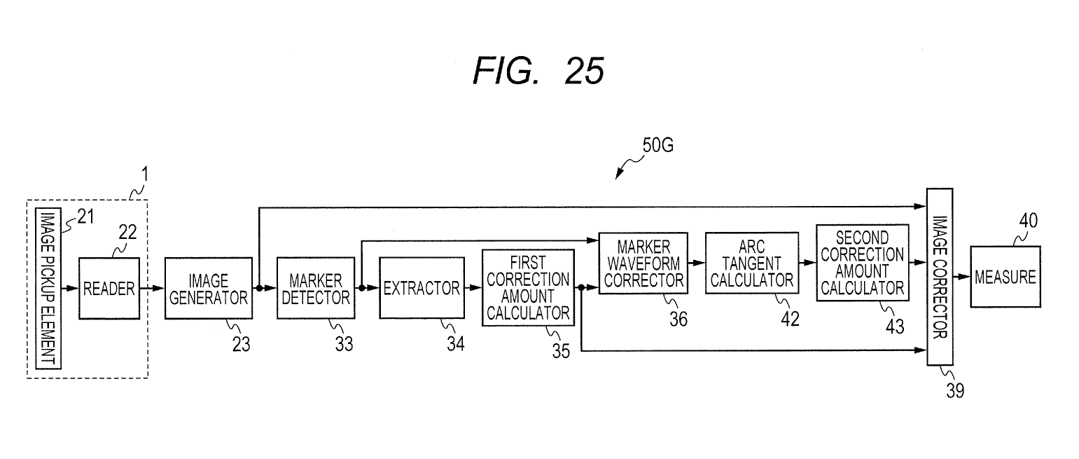

FIG. 25 is a functional block diagram of the camera 1 and the controller 50G of the image measurement apparatus 100G. The controller 50G includes an image generator 23, a marker detector 33, an extractor 34, a first correction amount calculator 35, a marker waveform corrector 36, an arc tangent calculator 42, a second correction amount calculator 43, an image corrector 39 and a measure 40. That is, the CPU 50a functions as the image generator 23, the marker detector 33, the extractor 34, the first correction amount calculator 35, the marker waveform corrector 36, the arc tangent calculator 42, the second correction amount calculator 43, the image corrector 39 and the measure 40.

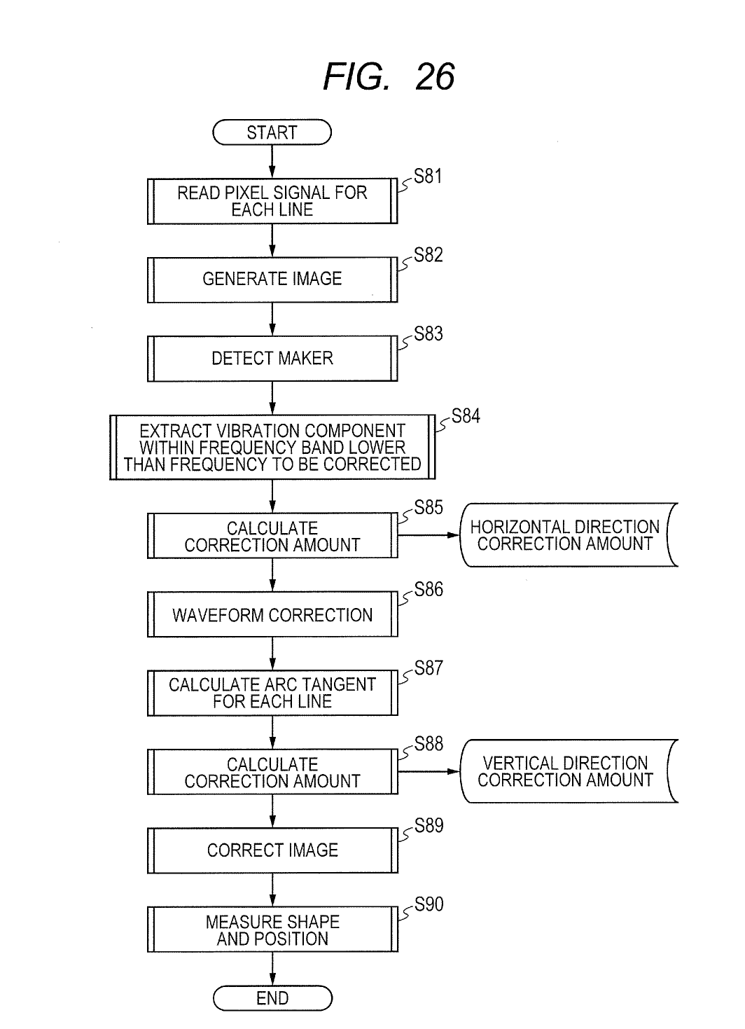

FIG. 26 is a flowchart illustrating an operation when measuring the position and the shape of the workpiece 6 by the camera 1 and the controller 50G. An operation of each unit of the camera 1 and the controller 50G is described with reference to the flowchart illustrated in FIG. 26.

In FIG. 26, processing operations in Steps S81 and S82 are the same as the processing operations in Steps S61 and S62 in FIG. 21. The marker detector 33 detects waveforms of the first marker 12G₁ and the second marker 12G₂ in the image 10G generated by the image generator 23 in Step S82 (Step S83: marker detecting step).

Subsequently, the extractor 34 extracts a vibration component within the frequency band B1 of a value smaller than a half of the spatial frequency f from the waveform of the first marker 12G₁ detected by the marker detector 33 in Step S83 ((j) of FIG. 19) (Step S84: extracting step). Although the vibration component is extracted from the waveform of the first marker 12G₁ in Step S84, the vibration component may be extracted from the waveform of the second marker 12G₂. That is, the vibration component may be extracted from the waveform of one of the markers.

After that, the first correction amount calculator 35 calculates a first correction amount in the horizontal scanning direction for each line, which cancels the vibration component extracted by the extractor 34 in Step S84 (Step S85: first correction amount calculating step). This first correction amount is stored in the memory (HDD 50d) by the CPU 50a.

Subsequently, the marker waveform corrector 36 corrects the waveforms of the first marker and the second marker detected by the marker detector 33 in Step S83 with the first correction amount in the horizontal scanning direction for each line (Step S86: marker waveform correcting step).

After that, the arc tangent calculator 42 calculates the arc tangent for each line by using the waveforms of the first marker and the second marker corrected by the marker waveform corrector 36 in Step S86 (Step S87: arc tangent calculating step). The results of calculating the arc tangent are phase values of the waveforms of the first marker and the second marker on the image on each line, from which the vibration component in the horizontal scanning direction is removed. That is, when an amplitude value of the waveform of the first marker on a line to be calculated is represented by X and an amplitude value of the waveform of the second marker on the line to be calculated is represented by Y, a phase value θ of the line is obtained as θ=tan⁻¹(X/Y). Therefore, the arc tangent calculator 42 obtains the phase value θ by using this computing equation. At this time, the arc tangent calculator 42 obtains the phase considering plus and minus of the sinusoidal wave and the cosine wave to measure a phase of ±180°.

Subsequently, the second correction amount calculator 43 calculates a second correction amount in the vertical scanning direction for each line from the phase value of the arc tangent obtained by the arc tangent calculator 42 in Step S87 (Step S88: second correction amount calculating step). Specifically, the second correction amount calculator 43 calculates an amount to shift, in the vertical scanning direction, a line of the phase value calculated by the arc tangent calculator 42 to a line of a phase value of the waveform of the marker when there is no vibration. For example, in a case where the phase value calculated by the arc tangent calculator 42 is 90° on a line L1, when a line of the phase value 90° obtained from a calculation of the arc tangent when there is no vibration is L2, a correction amount (second correction amount) for shifting pixel data of the line L1 to the line L2 is calculated.

After that, the image corrector 39 corrects the image generated by the image generator 23 in Step S82 in the horizontal scanning direction for each line with the first correction amount and in the vertical scanning direction for each line with the second correction amount (Step S89: image correcting step). With this operation, an image of the workpiece 6 with the distortion corrected is obtained.

Subsequently, the measure 40 measures the position and the shape of the workpiece 6 by using the image obtained from the correction by the image corrector in Step S89 (Step S90: measuring step). With this operation, a picture of the workpiece 6 that is corrected is obtained.

As described above, according to the seventh embodiment, the same effect as that in the above-mentioned fifth embodiment can be obtained. That is, an image distortion can be corrected without using an external sensor. Thus, the position and the shape of the workpiece 6 are obtained by using the image in which the distortion is corrected, and hence the accuracy of measuring the workpiece 6 is enhanced.

In addition, the correction of the image can be performed without using an external sensor, and hence the manufacturing cost can be lowered by the amount of excluding the external sensor and the space can be saved by the amount of excluding the external sensor. Further, none of the camera 1 and the support member 4 needs to include the external sensor and a synchronization circuit for the external sensor is not necessary as well, and hence the overall configuration can be simplified.

Further, according to the seventh embodiment, the phase lead and the phase lag are detected for each line directly by obtaining the arc tangent, and hence a higher speed can be expected than the case of extracting the frequency modulation component in the above-mentioned sixth embodiment.

Also in the case of the seventh embodiment, a measurement point may be obtained from the original image and a correction of only the measurement point may be performed in the vertical and horizontal directions. Further, although a case where the markers 3G₁ and 3G₂ extend in a direction parallel to the vertical scanning direction on the image is described as an example, the present invention is not limited to this scheme, and the markers 3G₁ and 3G₂ may extend in any direction as long as the direction is not parallel to the horizontal scanning direction. Specifically, the markers 3G₁ and 3G₂ may be arranged to intersect the horizontal scanning direction on the image.

Although the present invention is described based on the above-mentioned first to seventh embodiments, the present invention is not limited to those exemplary embodiments. Although a case where the computer-readable recording medium for recording the program is the ROM or the HDD is described in the above-mentioned first to seventh embodiments as an example, various recording media such as a CD and a DVD and non-volatile memories such as a USB memory and a memory card may be used instead. That is, any recording medium may be used as long as the program is recorded in a computer-readable manner, and the recording medium is not limited to the above examples. Further, the program for implementing the functions of the above-mentioned first to seventh embodiments in a computer may be provided to the computer via a network or various recording media so that the computer reads and executes program codes. In this case, the program and the computer-readable recording medium recording the program also constitute the present invention.

Moreover, although a case where the second extractor 37 includes the PLL circuit 50e and the LPF circuit 50f is described in the above-mentioned fifth and sixth embodiments as an example, the present invention is not limited to this scheme. The CPU 50a as a computer that operates based on the program may include the function of the second extractor 37.

In addition, although a case where the CPU 50a includes the function of the image generator is described in the above-mentioned first to seventh embodiments, the camera 1 may include the function of the image generator instead.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2011-162770, filed Jul. 26, 2011, which is hereby incorporated by reference herein in its entirety.

What is claimed is:

1. An image measurement apparatus, comprising:
a camera including an image sensor having a plurality of pixels, the camera being configured to capture an image of an object to be measured by sequentially exposing the plurality of pixels of the image sensor for each line in a first scanning direction;
a computation processing unit configured to obtain a picture of the object to be measured from the image captured by the camera; and
a support member configured to support the object to be measured, the support member including a plurality of markers arranged in a manner intersecting the first scanning direction with a predetermined relative position therebetween,
wherein the computation processing unit is configured to:
detect positions of the plurality of markers on the image;
obtain shift amounts of the positions of the plurality of markers in the first scanning direction and a second scanning direction with respect to reference positions of the plurality of markers for each line of the image; and
obtain the picture of the object to be measured, the picture being corrected so that the shift amounts are canceled.

2. An image measurement apparatus according to claim 1, wherein the plurality of markers are arranged on the support member along the second scanning direction.

3. An image measurement apparatus according to claim 1, further comprising a rotator configured to rotate the support member in a plane parallel to an image surface of the image sensor.

4. An image measurement apparatus according to claim 1, wherein the first scanning direction is perpendicular to the second scanning direction.

5. An image measurement apparatus, comprising:
a camera including an image sensor having a plurality of pixels, the camera being configured to capture an image of an object to be measured by sequentially exposing the plurality of pixels of the image sensor for each line in a first scanning direction;
a computation processing unit configured to obtain a picture of the object to be measured from the image captured by the camera; and
a support member configured to support the object to be measured, the support member including a marker having a sinusoidal shape and a known spatial frequency, the marker extending in a direction intersecting the first scanning direction,
wherein the computation processing unit is configured to:
extract a vibration component within a frequency band of a value smaller than a half of the known spatial frequency from a waveform of the marker on the image;
obtain a first correction amount in the first scanning direction for each line, which cancels the vibration component;
correct the waveform of the marker on the image with the first correction amount in the first scanning direction for each line;
extract a frequency modulation component of the corrected waveform of the marker;
obtain a second correction amount in a second scanning direction for each line, which cancels the frequency modulation component; and
obtain the picture of the object to be measured, the picture being corrected with the first correction amount and the second correction amount.

6. An image measurement apparatus according to claim 5, wherein the first scanning direction is perpendicular to the second scanning direction.

7. An image measurement apparatus, comprising:
a camera including an image sensor having a plurality of pixels, the camera being configured to capture an image of an object to be measured by sequentially exposing the plurality of pixels of the image sensor for each line in a first scanning direction;
a computation processing unit configured to obtain a picture of the object to be measured from the image captured by the camera; and
a support member configured to support the object to be measured, the support member including a first marker having a sinusoidal shape and a second marker having a cosine-wave shape, which have a known spatial frequency and extend in a direction intersecting the first scanning direction, the second marker having a phase difference of 90° with respect to the first marker,
wherein the computation processing unit is configured to:
extract a vibration component within a frequency band of a value smaller than a half of the known spatial frequency from a waveform of one of the first marker and the second marker on the image;
obtain a first correction amount in the first scanning direction for each line, which cancels the vibration component;
correct the waveform of the first marker and the waveform of the second marker on the image with the first correction amount in the first scanning direction for each line;
obtain an arc tangent for each line by using the corrected waveform of the first marker and the corrected waveform of the second marker;
obtain a second correction amount in a second scanning direction for each line from a phase value of the arc tangent; and
obtain the picture of the object to be measured, the picture being corrected with the first correction amount and the second correction amount.

8. An image measurement apparatus according to claim 7, wherein the first scanning direction is perpendicular to the second scanning direction.

9. An image measurement method, which uses an image measurement apparatus including:
a camera including an image sensor having a plurality of pixels, the camera being configured to capture an image of an object to be measured by sequentially exposing the plurality of pixels of the image sensor for each line in a first scanning direction;
a computation processing unit configured to obtain a picture of the object to be measured from the image captured by the camera; and
a support member configured to support the object to be measured, the support member including a plurality of markers arranged in a manner intersecting the first scanning direction with a predetermined relative position therebetween,
the image measurement method comprising:
detecting, by the computation processing unit, positions of the plurality of markers on the image;
obtaining, by the computation processing unit, shift amounts of the positions of the plurality of markers in the first scanning direction and a second scanning direction with respect to reference positions of the plurality of markers for each line of the image; and
obtaining, by the computation processing unit, the picture of the object to be measured, the picture being corrected so that the shift amounts are canceled.

10. An image measurement method according to claim 9, wherein the first scanning direction is perpendicular to the second scanning direction.

11. An image measurement method, which uses an image measurement apparatus including:
a camera including an image sensor having a plurality of pixels, the camera being configured to capture an image of an object to be measured by sequentially exposing the plurality of pixels of the image sensor for each line in a first scanning direction;
a computation processing unit configured to obtain a picture of the object to be measured from the image captured by the camera; and
a support member configured to support the object to be measured, the support member including a marker having a sinusoidal shape and a known spatial frequency, the marker extending in a direction intersecting the first scanning direction,
the image measurement method comprising:
extracting, by the computation processing unit, a vibration component within a frequency band of a value smaller than a half of the known spatial frequency from a waveform of the marker on the image;
obtaining, by the computation processing unit, a first correction amount in the first scanning direction for each line, which cancels the vibration component;
correcting, by the computation processing unit, the waveform of the marker on the image with the first correction amount in the first scanning direction for each line;
extracting, by the computation processing unit, a frequency modulation component of the corrected waveform of the marker;
obtaining, by the computation processing unit, a second correction amount in a second scanning direction for each line, which cancels the frequency modulation component; and
obtaining, by the computation processing unit, the picture of the object to be measured, the picture being corrected with the first correction amount and the second correction amount.

12. An image measurement method according to claim 11, wherein the first scanning direction is perpendicular to the second scanning direction.

13. An image measurement method, which uses an image measurement apparatus including:
a camera including an image sensor having a plurality of pixels, the camera being configured to capture an image of an object to be measured by sequentially exposing the plurality of pixels of the image sensor for each line in a first scanning direction;
a computation processing unit configured to obtain a picture of the object to be measured from the image captured by the camera; and
a support member configured to support the object to be measured, the support member including a first marker having a sinusoidal shape and a second marker having a cosine-wave shape, which have a known spatial frequency and extend in a direction intersecting the first scanning direction, the second marker having a phase difference of 90° with respect to the first marker,
the image measurement method comprising:
extracting, by the computation processing unit, a vibration component within a frequency band of a value smaller than a half of the known spatial frequency from a waveform of one of the first marker and the second marker on the image;
obtaining, by the computation processing unit, a first correction amount in the first scanning direction for each line, which cancels the vibration component;
correcting, by the computation processing unit, the waveform of the first marker and the waveform of the second marker on the image with the first correction amount in the first scanning direction for each line;
obtaining, by the computation processing unit, an arc tangent for each line by using the corrected waveform of the first marker and the corrected waveform of the second marker;
obtaining, by the computation processing unit, a second correction amount in a second scanning direction for each line from a phase value of the arc tangent; and
obtaining, by the computation processing unit, the picture of the object to be measured, the picture being corrected with the first correction amount and the second correction amount.

14. An image measurement method according to claim 13, wherein the first scanning direction is perpendicular to the second scanning direction.

15. A program for causing a computer to execute the image measurement method according to claim 9.

16. A computer-readable recording medium recording therein the program according to claim 14.
